(19) United States
(12) Patent Application Publication
(10) Pub. No.: US 2026/0345432 A1
(43) Pub. Date: Nov. 5, 2026

(54) GARMENT WITH ONE OR MORE OSCILLATING MOTORS

(71) Applicant: TACTILE SYSTEMS TECHNOLOGY, INC., Minneapolis, MN (US)

(72) Inventors: Gabriele J.R. Perkins, St. Louis Park, MN (US); Derek Hegna, Golden Vallley, MN (US); Michael P. Scharlau, Minneapolis, MN (US); Nicole Dunn, Pittsburgh, PA (US); Veronica Becker, Minneapolis, MN (US); Ronald Graczyk, Cedar Park, TX (US)

(21) Appl. No.: 19/662,563

(22) Filed: Apr. 29, 2026

Related U.S. Application Data
(60) Provisional application No. 63/797,266, filed on Apr. 30, 2025.

(51) Int. Cl. A61H 23/02

(52) U.S. Cl. CPC A61H 23/02; A61H 2201/1207; A61H 2201/165; A61H 2201/5025; A61H 2205/08

(57) ABSTRACT

A garment to provide oscillatory therapy to a patient and including a posterior panel, a left panel coupled to the posterior panel, and a right panel coupled to the posterior panel. The garment further includes a fastening system configured to couple the garment to the patient and to adjust a fit of the garment to the patient and including: one or more front straps configured to selectively couple the left panel to the right panel, a left shoulder strap configured to selectively couple the left panel and the posterior panel over the patient’s left shoulder, a right shoulder strap configured to selectively couple the right panel and the posterior panel over the patient’s right shoulder, an adjustable left side strap coupled to the left panel and the posterior panel, and an adjustable right side strap coupled to the right panel and the posterior panel.

This application claims the benefit of U.S. Provisional Application No. 63/797,266, filed April 30, 2025, the disclosure of which is incorporated by reference herein in its entirety.

The present application is directed to a garment and, more particularly, to a self-contained portable garment with one or more oscillating motors configured to provide oscillation therapy to a patient wearing the garment.

Subjects who are unable to mobilize their own lung secretions without assistance (subjects with, for example, bronchiectasis, cystic fibrosis, or other chronic respiratory conditions) are exceedingly common and may account for over 1 million hospitalizations each year in the United States alone. In healthy individuals, secretion (defined herein as a substance, e.g., mucus) clearance from the respiratory tract is primarily achieved through the body's normal mucociliary action and coughing. These mechanisms are usually efficient. However, when the mucociliary transport system is impaired or there is excessive secretion, it can lead to secretion and debris accumulation in the lungs. This can cause severe medical complications such as hypoxemia, hypercapnia, and pneumonia. Abnormal secretion clearance is associated with various medical conditions, including cystic fibrosis, bronchiectasis, and neuromuscular conditions. Mucus thinning agents, antibiotics and bronchodilators are recommended to treat patients with bronchiectasis. Some of these are delivered in aerosolized forms. These medications rely on deposition into distal airspaces to thin the mucus, reduce infection or promote bronchodilation. Excessive secretion production and impaired airway mucociliary clearance can lead to airway plugging, and thereby reduce the deposition of and response to aerosolized medications. These considerations highlight the need for therapies that clear airways of secretions in the management of diseases such as cystic fibrosis, bronchiectasis, and certain neuromuscular diseases.

Manual percussion techniques of chest physiotherapy have been used for a variety of diseases, such as cystic fibrosis, bronchiectasis, and chronic respiratory infections, to remove excess mucus that collects in the lungs. To bypass dependency on a caregiver to provide this therapy, chest compression and oscillation devices have been developed to produce High Frequency Chest Wall Oscillation (HFCWO), a successful method of airway clearance. HFCWO creates high velocity, low amplitude oscillation energy when applied through a vest worn over the thorax and is used for airway mucus clearance in patients with cystic fibrosis, bronchiectasis, and neuromuscular disorders. Studies in patients with cystic fibrosis suggest that HFCWO applied via a vest is as effective as other modes of airway mucus clearance, including hand-held devices (e.g., flutter devices) and conventional chest physiotherapy. Moreover, HFCWO can be performed without the assistance from trained health care personnel and may therefore offer a practical advantage compared to chest physiotherapy.

At least in part as a result of rising health care costs, rehabilitation programs are often being performed in a patient's home without a visiting therapist being physically present. However, at-home rehabilitation programs suffer from difficulty in donning and using medical devices without assistance, and also suffer from compliance and monitoring deficiencies. The patient may struggle to put a garment on properly and may struggle to adjust the garment to best fit them without help from a medical professional or someone else. The patient may further struggle to use the controller if the buttons are too small and they do not have the necessary dexterity in their fingers to engage a specific button from a variety of buttons, which may be located close together. A medical professional, on the other hand, has no way to determine whether the patient followed the rehabilitation program and must rely on the office visit to ascertain progress.

Additionally, if the garment needs maintenance or repairs, it may be difficult to access certain components of the garment to perform such maintenance or repairs. In some instances, garments with inner components may also undergo stress and damage during garment use, depending on the interior component design of the garment.

Still further, as physicians prescribe many medical devices, the opportunity to collect reliable data is often limited to those patient visits that occur at prescribed intervals. There are many reasons that make it highly desirable to have accurate patient compliance data for a medical device used on an outpatient basis. One of these reasons includes the desirability of collecting data for a large group of individuals, which may then be used to make considered judgments relating to the medical device's efficacy and recommended regimen for optimal results. For these kinds of studies, accurate data is imperative. Still, another reason for collecting accurate data is that immediate feedback and positive reinforcement may be provided to the patient, encouraging them to follow the regimen. A medical professional may use this accurate compliance data in order to correct the patient should she not only under-use but over-use the device in an effort to achieve even greater results by increasing her wearing times beyond that which is recommended. This can help prevent unintended side effects through over-use of any medical device.

Therefore, there remains a need for systems and methods that clear airways of mucus/secretions in the management of diseases such as cystic fibrosis, bronchiectasis, and certain neuromuscular diseases. Further, there remains a need for systems and methods that ensure the patient is correctly donning and using a garment with one or more oscillating motors. Further, there remains a need for systems and methods that include an easy-to-use control unit. Further, there remains a need for systems and methods that include an easily accessible inner compartment, for example, for maintenance and repairs.

### SUMMARY

Embodiments described herein may provide a garment to provide therapy to a patient. The garment may include a plurality of panels. The plurality of panels may include a posterior panel configured to be positioned adjacent the patient’s back, a left panel coupled to the posterior panel and configured to be positioned adjacent the patient’s left front torso, and a right panel coupled to the posterior panel and configured to be positioned adjacent the patient’s right front torso. The garment may further include a fastening system configured to couple the garment to the patient. The fastening system may be further configured to adjust a fit of the garment to the patient. The fastening system may include one or more front straps configured to selectively couple the left panel to the right panel. The one or more front straps may be further configured to modify the fit of the garment to the patient. The fastening system may further include a left shoulder strap configured to selectively couple the left panel and the posterior panel over a left shoulder of the patient. The left shoulder strap may be further configured to modify the fit of the garment to the patient. The fastening system may further include a right shoulder strap configured to selectively couple the right panel and the posterior panel over a right shoulder of the patient. The right shoulder strap may be further configured to modify the fit of the garment to the patient. The fastening system may further include an adjustable left side strap coupled to the left panel and the posterior panel and configured to adjust the fit of the garment to the patient. The fastening system may further include an adjustable right side strap coupled to the right panel and the posterior panel, the adjustable right side strap configured to adjust the fit of the garment to the patient. The garment may further include one or more motors configured to apply an oscillation force to at least one treatment area of the patient to mobilize secretions in an airway within the patient at least proximate the at least one treatment area. The garment may further include a control unit coupled to the one or more motors and the garment and configured to control the one or more motors to affect treatment of the patient.

Embodiments described herein may provide a garment to provide therapy to a patient. The garment may include a plurality of panels. The plurality of panels may include a posterior panel configured to be positioned adjacent the patient’s back, a left panel coupled to the posterior panel and configured to be positioned adjacent the patient’s left front torso, and a right panel coupled to the posterior panel and configured to be positioned adjacent the patient’s right front torso. The garment may further include a fastening system configured to couple the garment to the patient. The fastening system may be further configured to adjust a fit of the garment to the patient. The garment may further include one or more motors configured to apply an oscillation force to at least one treatment area of the patient to mobilize secretions in an airway within the patient at least proximate the at least one treatment area. The garment may further include electrical wiring electrically coupling each of the one or more motors to a power source. The garment may further include an accessible inner compartment defined by at least one of the plurality of panels. The accessible inner compartment may be configured to retain at least a portion of the electrical wiring. The garment may further include one or more guiding straps positioned within the accessible inner compartment. The one or more guiding straps may be configured to guide the electrical wiring throughout the accessible inner compartment.

Embodiments described herein may provide a method of clearing a biological airway. The method may include positioning a garment on a torso of a patient. The garment may include one or more motors and a fastening system. The fastening system may include at least one front strap, a right shoulder strap, a left shoulder strap, a right side strap, and a left side strap. The method may further include adjusting the garment to fit the patient using the fastening system. The method may further include applying an oscillation force to at least one treatment area using at least one of the one or more motors such that at least some secretions in an airway within the patient substantially adjacent the at least one treatment area are mobilized.

The above summary is not intended to describe each embodiment or every implementation. Rather, a more complete understanding of illustrative embodiments will become apparent and appreciated by reference to the following Detailed Description of Exemplary Embodiments and claims in view of the accompanying figures of the drawing.

### BRIEF DESCRIPTION OF THE VIEWS OF THE DRAWINGS

Exemplary embodiments will be further described with reference to the figures of the drawing, wherein:

FIG. 1 is a front perspective view of a garment according to embodiments of the present disclosure;

FIG. 2 is a left side perspective view of the garment of FIG. 1;

FIG. 3 is a right side perspective view of the garment of FIG. 1;

FIG. 4 is a top right perspective view of the garment of FIG. 1;

FIG. 5 is a top perspective view of the garment of FIG. 1;

FIG. 6 is a rear perspective view of the garment of FIG. 1;

FIG. 7 is an inner front perspective view of the garment of FIG. 1 in an unfolded configuration;

FIG. 8 is a rear perspective view of the garment of FIG. 1 in an unfolded configuration;

FIG. 9 is a bottom perspective view of the garment of FIG. 1;

FIG. 10 is an inner front perspective view of a garment according to embodiments of the present disclosure, the garment in an unfolded configuration;

FIG. 11 is a rear perspective view of the garment of FIG. 10 in an unfolded configuration;

FIG. 12 is another inner front perspective view of the garment of FIG. 10 in an unfolded configuration and illustrating possible locations of one or more motors;

FIG. 13 is a front perspective view of the garment of FIG. 10 in a folded and closed configuration;

FIG. 14 is a partial view of a battery pocket of the garment of FIG. 10;

FIG. 15 is a partial view of a controller in a controller pocket of the garment of FIG. 10;

FIG. 16 is a front view of the controller of the garment of FIG. 10;

FIG. 17 is a partial bottom perspective view of the garment of FIG. 10;

FIG. 18 is a partial front perspective view of the garment of FIG. 10 with interior wiring illustrated;

FIG. 19 is a partial bottom perspective view of the garment of FIG. 10 with interior wiring illustrated;

FIG. 20 is a partial bottom perspective view of the garment of FIG. 10 with interior wiring illustrated;

FIG. 21 is a partial bottom perspective view of the garment of FIG. 10 with interior wiring illustrated;

FIG. 22 is a partial view of a circuit board of the garment of FIG. 10;

FIG. 23 is a method of clearing a biological airway using the garment of any of FIGS. 1-22; and

FIG. 24 is a schematic view of the layers of each of the plurality of panels of the garment of any of FIGS. 1-22.

The figures are rendered primarily for clarity and, as a result, are not necessarily drawn to scale. Moreover, various structures/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION OF EXEMPLARY EMBODIMENTS

In the following detailed description of illustrative embodiments, reference is made to the accompanying figures of the drawing that form a part hereof. It is to be understood that other embodiments, which may not be described and/or illustrated herein, are certainly contemplated.

All headings provided herein are for the convenience of the reader and should not be used to limit the meaning of any text that follows the heading, unless so specified. Moreover, unless otherwise indicated, all numbers expressing quantities, and all terms expressing direction/orientation (e.g., vertical, horizontal, parallel, perpendicular, etc.) in the specification and claims are to be understood as being modified in all instances by the term “about.” The term “and/or” (if used) means one or all of the listed elements or a combination of any two or more of the listed elements. The term “i.e.” is used as an abbreviation for the Latin phrase id est and means “that is.” The term “e.g.” is used as an abbreviation for the Latin phrase exempli gratia and means “for example.”

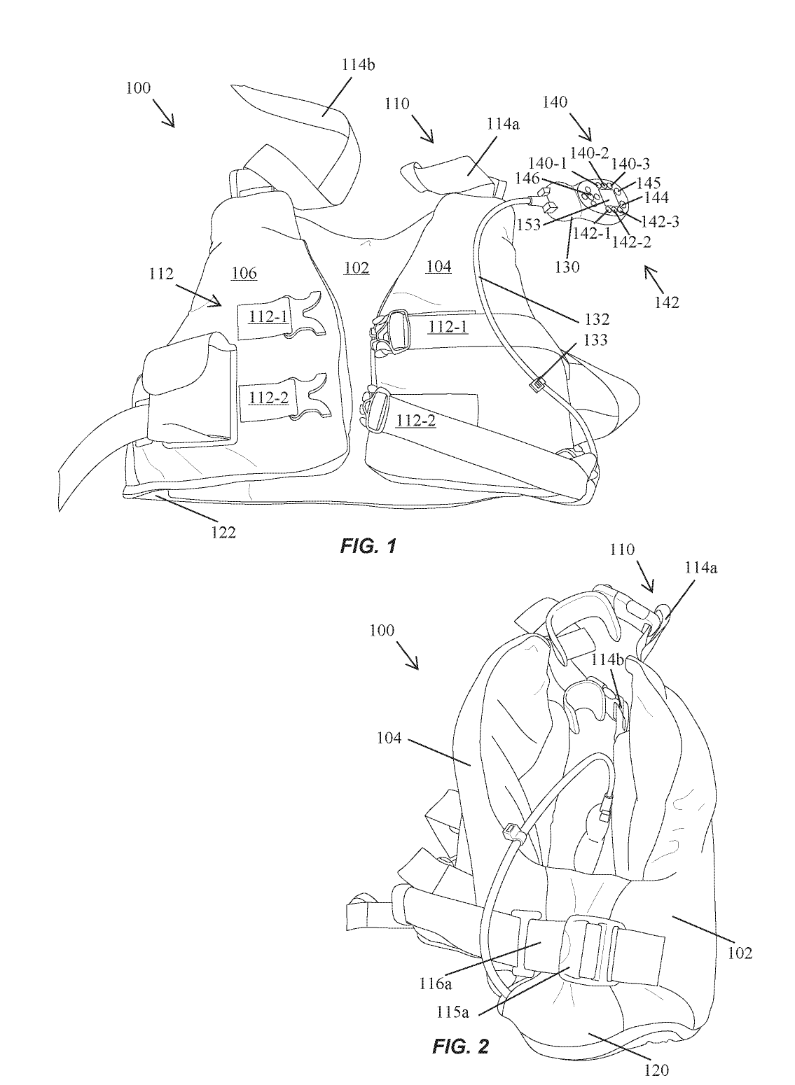

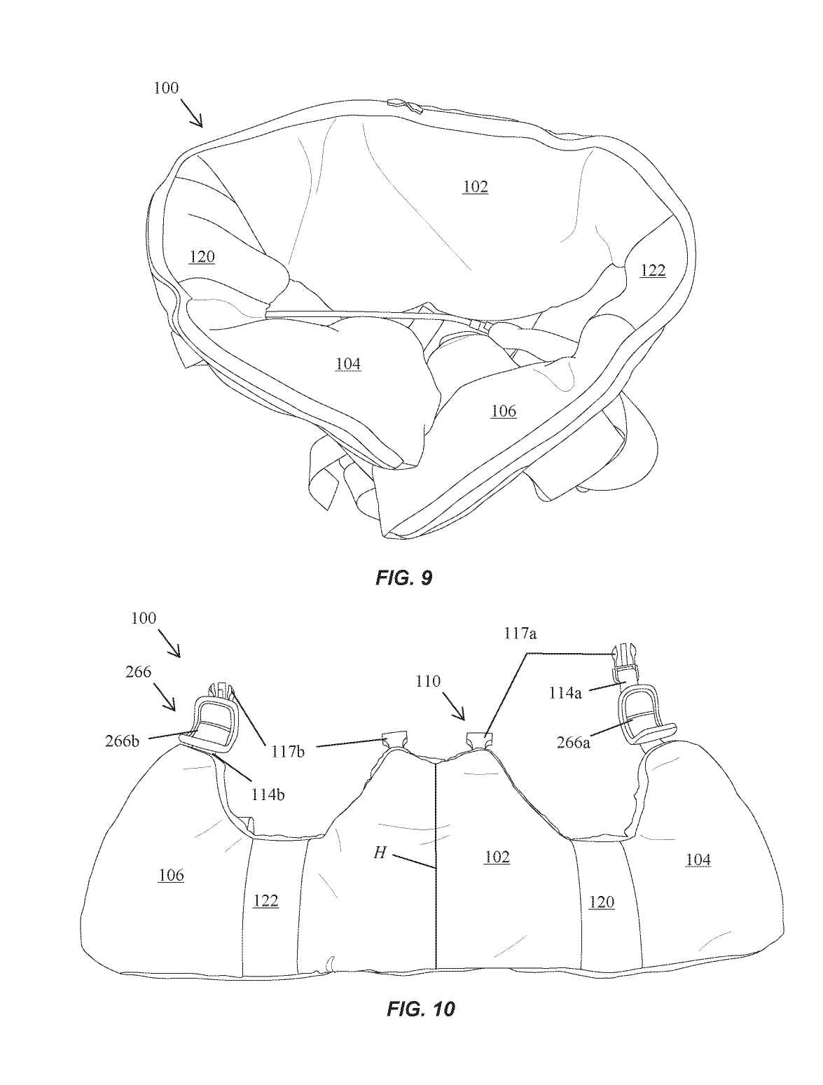

Embodiments of the present disclosure may be generally directed to a garment 100 as shown in FIGS. 1-22. While not limited to such, such an illustrative garment 100 may be configured as an upper body garment, such as a vest. Moreover, while shown as a vest configured to include various elements, other embodiments may be configured as a T-shirt, a long-sleeve shirt, a dress, a hooded garment, etc. The terms “garment,” “upper body garment,” “torso garment,” “vest,” and “HFCWO garment,” may be used interchangeably herein without limitation.

Additionally, the garment 100 shown in FIGS. 1-9 and the garment 100 shown in FIGS. 10-23 may or may not illustrate certain elements (e.g., control unit pocket 229, garment aperture 233, power source charging cable 256, garment aperture 258, zipper 260, and zipper pocket 262 are shown only in some of FIGS. 10-23), but it is to be understood that any element described for the garment 100 of FIGS. 1-9 is also applicable to the garment 100 of FIGS. 10-23, unless otherwise noted herein.

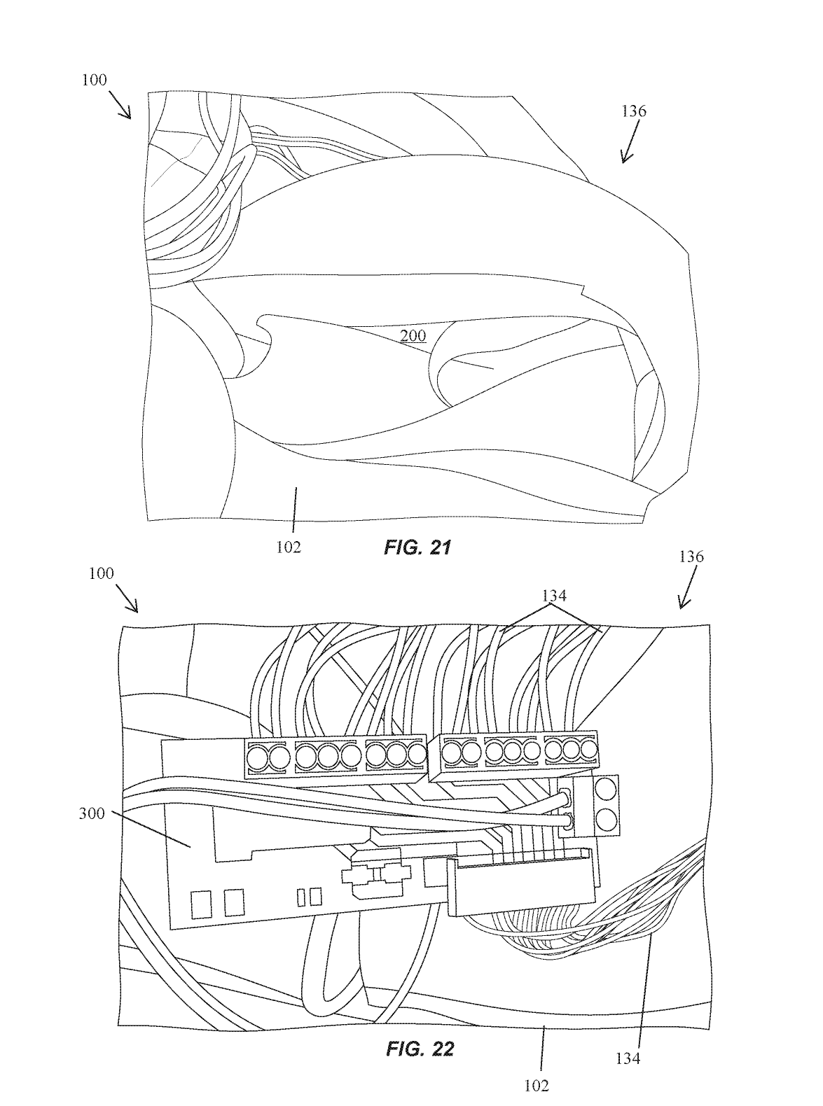

As illustrated in FIGS. 1 and 10, the garment 100 may include a plurality of panels (e.g., a posterior panel 102, a left panel 104, and a right panel 106). The posterior panel 102 may be configured to be positioned adjacent a patient’s back. The left panel 104 may be coupled to the posterior panel 102. The left panel 104 may be configured to be positioned adjacent the patient’s left front torso. The right panel 106 may be coupled to the posterior panel 102. The right panel 106 may be configured to be positioned adjacent the patient’s right front torso. Moreover, as described in more detail below, the garment 100 may include a fastening system 110 configured to couple the garment 100 to the patient and to adjust a fit of the garment 100 to the patient. “Fit” as used throughout herein may refer to one or more of: an adjustable circumferential fit, an adjustable torso surface fit, a garment height, etc., as matched to the patient’s anatomy for purposes of providing therapy to clear the patient’s airways of secretions (e.g., mucus). For example, a well-fit garment 100 may target one or more lung lobes to clear the patient’s airway of secretions, the lung lobes as discussed further herein. Moreover, as described in more detail below, the garment 100 may include one or more motors (e.g., motor 200, FIGS. 12 and 21), each motor 200 configured to apply an oscillation force to at least one treatment area of the patient to mobilize secretions in an airway within the patient. Further, secretions may be mobilized in an airway at least proximate the treatment area.

It is noted that the terms “have,” “include,” “comprise,” and variations thereof, do not have a limiting meaning, and are used in their open-ended sense to generally mean “including, but not limited to,” where the terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective shown in the particular figure, or while the garment 100 is in an operating configuration (e.g., while the garment 100 is positioned on a user and closed as shown in FIG. 4). These terms are used only to simplify the description, however, and not to limit the interpretation of any embodiment described. In a similar manner, terms such as “first” and “second” may be used herein to describe various elements. However, such terms are used merely to distinguish one of the elements from the other. It is further understood that the description of any particular element as being attached, connected, or coupled to another element may indicate that the elements are either directly attached, connected or coupled to one another, or are indirectly attached, coupled, or connected to one another via intervening elements.

Still further, the suffixes “a” and “b” may be used throughout this description to denote various left- and right-side parts/features, respectively. However, in most pertinent respects, the parts/features denoted with “a” and “b” suffixes are substantially identical to, or mirror images of, one another. It is understood that, unless otherwise noted, the description of an individual part/feature (e.g., part/feature identified with an “a” suffix) also applies to the opposing part/feature (e.g., part/feature identified with a “b” suffix). Similarly, the description of a part/feature identified with no suffix may apply, unless noted otherwise, to both the corresponding left and right part/feature.

### The Garment

As illustrated in each of FIGS. 1-13 and 17-22, the garment 100 may include the plurality of panels, the plurality of panels including the posterior panel 102. The posterior panel 102 may be configured to be positioned adjacent the patient’s back. The posterior panel 102 may be shaped and sized in any way, and may be shaped and sized to position at least one motor (200, FIGS. 12 and 21) adjacent the patient’s back. The posterior panel 102 may be shaped and sized to position at least one motor adjacent a lung lobe of the patient to assist in clearing airways of secretions. The posterior panel 102 may further be shaped and sized to minimize weight on the patient’s back. A lighter garment may be more comfortable for a patient. For example, the posterior panel 102 may cover at least 10% of the patient’s back, or at least 25%, or at least 50%, or at least 75%, etc., of the patient’s back, and/or may cover no more than 95% of the patient’s back, or no more than 80%, or no more than 40%, etc., of the patient’s back. The posterior panel 102 may further be shaped and sized to provide patient comfort. For example, the posterior panel 102 may provide padding such that the patient may lean back against a surface with minimal to no discomfort while wearing the garment 100.

As illustrated in each of FIGS. 1, 2, 4, 5, 7-13 and 17-20, the plurality of panels may include the left panel 104. The left panel 104 may be configured to be positioned adjacent the patient’s left front torso. The left panel 104 may be shaped and sized in any way, and may be shaped and sized to position at least one motor (200, FIGS. 12 and 21) adjacent the patient’s left front torso. The left panel 104 may be shaped and sized to position at least one motor adjacent a lung lobe of the patient to assist in clearing airways of secretions. The left panel 104 may further be shaped and sized to minimize weight on the patient’s left front torso. A lighter garment may be more comfortable for a patient. For example, the left panel 104 may cover at least 10% of the patient’s left front torso, or at least 25%, or at least 50%, or at least 75%, etc., of the patient’s left front torso, and/or may cover no more than 95% of the patient’s left front torso, no more than 80%, no more than 40%, etc., of the patient’s left front torso. The left panel 104 may be further shaped and sized to provide patient comfort. For example, the left panel 104 may provide padding such that the patient may lean against a surface with minimal to no discomfort while wearing the garment 100.

As illustrated in each of FIGS. 1, 3-5, 7-14, 18, and 19, the plurality of panels may include the right panel 106. The right panel 106 may be configured to be positioned adjacent the patient’s right front torso. The right panel 106 may be shaped and sized in any way, and may be shaped and sized to position at least one motor (200, FIGS. 12 and 21) adjacent the patient’s right front torso. The right panel 106 may be shaped and sized to position at least one motor adjacent a lung lobe of the patient to assist in clearing airways of secretions. The right panel 106 may further be shaped and sized to minimize weight on the patient’s right front torso. A lighter garment may be more comfortable for a patient. For example, the right panel 106 may cover at least 10% of the patient’s right front torso, or at least 25%, or at least 50%, or at least 75%, etc., of the patient’s right front torso, and/or may cover no more than 95% of the patient’s right front torso, or no more than 80%, or no more than 40%, etc., of the patient’s right front torso. The right panel 106 may further be shaped and sized to provide patient comfort. For example, the right panel 106 may provide padding such that the patient may lean against a surface with minimal to no discomfort while wearing the garment 100.

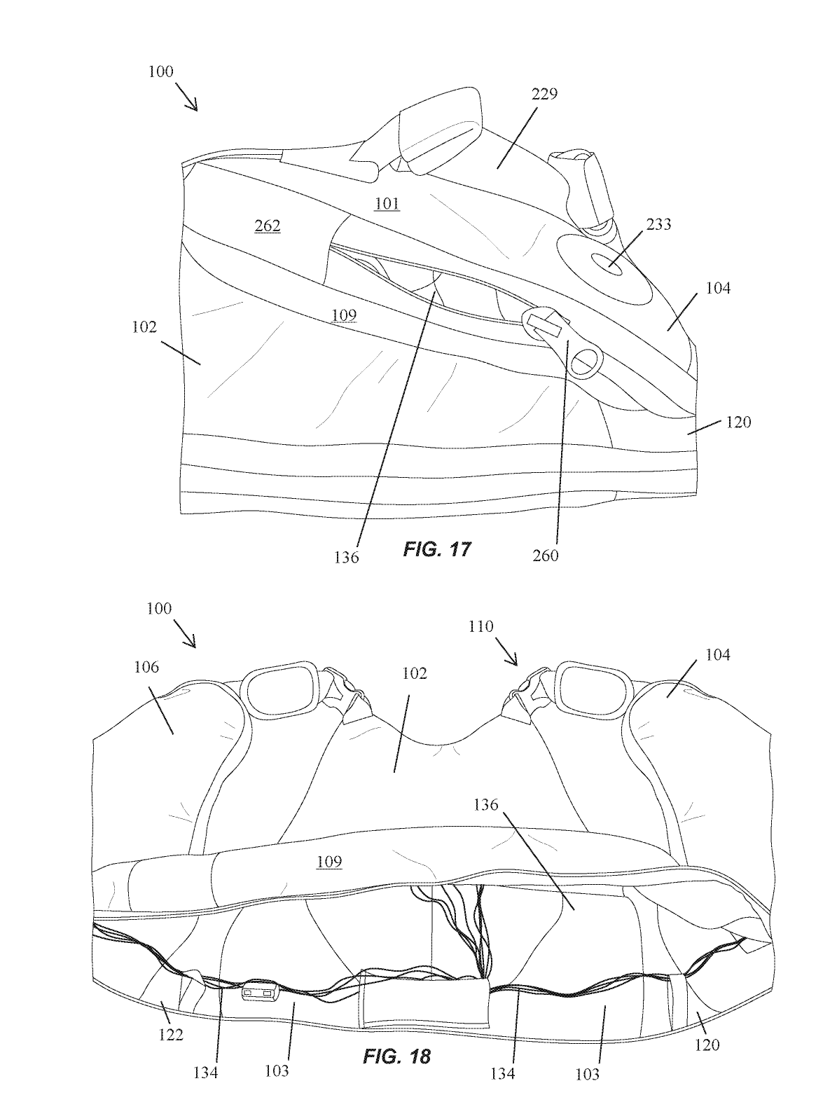

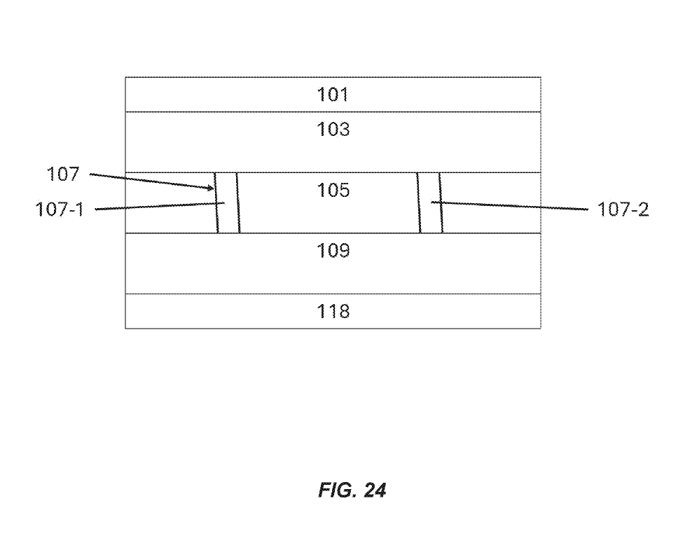

As illustrated in FIGS. 17-18 and 24, each of the posterior panel 102, the left panel 104, and the right panel 106 may include one or more layers of material. For example, each of the plurality of panels may include a first outer layer 101 distal to the patient. Each of the plurality of panels may further include a first inner layer 103 between the first outer layer 101 and the one or more motors (200, FIGS. 12 and 21). Each of the plurality of panels may further include a second inner layer 105 laterally surrounding each of the one or more motors, with through holes or pockets 107 (e.g., 107-1, 107-2) each configured to retain a motor. Each of the plurality of panels may further include a third inner layer 109 between each of the one or more motors and the patient. Each of the plurality of panels may further include a second outer layer 118 between the third inner layer 109 and the patient, the second outer layer 118 proximal to the patient.

Each of the first and second outer layers 101, 118 may be constructed out of nylon or another synthetic thermoplastic polymer, or any combination thereof. Nylon may provide a wear-resistant external material. Additionally, each of the first and second outer layers 101, 118 may include a coated material (e.g., water-resistant or waterproof coating). Each of the first, second, and third inner layers 103, 105, 109 may be constructed out of neoprene or another synthetic rubber, foam, or any combination thereof. Each of the first, second, and third inner layers 103, 105, 109 may be water-resistant or waterproof. Water-resistant or waterproof material may help protect the internal components of the garment 100. Water-resistant or waterproof material may help extend the lifetime of the garment 100 and avoid degradation of the garment 100. Additionally or alternatively, each of the first, second, and third inner layers 103, 105, 109 may include a coated material (e.g., water-resistant or waterproof coating), which may help protect the internal components of the garment 100 and/or extend the lifetime of the garment 100.

The second inner layer 105 may include or define pockets 107 (e.g., 107-1, 107-2). Each of the pockets 107 may be a through hole. Each of the pockets 107 may house a motor (200, FIGS. 12 and 21) and/or electrical wiring extending from the respective motor. Each of the pockets 107 may define a two-dimensional shape as measured generally transverse to the second inner layer 105. The pocket 107 two-dimensional shape may be, for example, a rectangle, a circle, an oval, a hexagon, etc. The pockets 107 may further be configured to securely house one or more of: the motor and the electrical wiring, such that the motors and/or electrical wiring does not shift relative to the second inner layer 105. In alternative embodiments, the motors and/or electrical wiring may slightly shift relative to the second inner layer 105 (e.g., 1 centimeter or less). Further, the materials of each of the layers 101, 103, 105, 109, and 118 may protect the motor(s) and/or other internal components discussed further herein.

The left panel 104 may be coupled to the posterior panel 102. The left panel 104 may be directly or indirectly coupled to the posterior panel 102. As illustrated in FIGS. 2, 6-12, and 17-19, the left panel 104 may be indirectly coupled to the posterior panel 102 via a left flexible element 120. The left flexible element 120 may be coupled to and extend between the left panel 104 and the posterior panel 102. The left flexible element 120 may be constructed of a flexible material such as, for example, polychloroprene, polyester, nylon, spandex, or any combination thereof. The left flexible element 120 may allow the garment 100 to fit a variety of torso circumferences within a circumference range (the circumference ranges as discussed further herein). The left flexible element 120 may be stretchable, as well as compressible, to achieve the advantage of fitting a variety of torso circumferences. Moreover, the left flexible element 120 may be breathable such that it allows body heat to escape from the patient, helping to regulate patient temperature while the patient wears the garment 100. The left flexible element 120 may also act as a housing to pass electrical wiring (discussed further herein) between the left panel 104 and the posterior panel 102. In alternative embodiments where the left panel 104 is directly coupled to the posterior panel 102, the panels may be integral with one another.

The right panel 106 may be coupled to the posterior panel 102. The right panel 106 may be directly or indirectly coupled to the posterior panel 102. As illustrated in FIGS. 1, 3, 6-12, 18, and 19, the right panel 106 may be indirectly coupled to the posterior panel 102 via a right flexible element 122. The right flexible element 122 may be coupled to and extend between the right panel 106 and the posterior panel 102. The right flexible element 122 may be constructed of a flexible material such as, for example, polychloroprene, polyester, nylon, spandex, or any combination thereof. The right flexible element 122 may allow the garment 100 to fit a variety of torso circumferences within a circumference range (the circumference ranges as discussed further herein). The right flexible element 122 may be stretchable, as well as compressible, to achieve the advantage of fitting a variety of torso circumferences. Moreover, the right flexible element 122 may be breathable such that it allows body heat to escape from the patient, helping to regulate patient temperature while the patient wears the garment 100. The right flexible element 122 may also act as a housing to pass electrical wiring (discussed further herein) between the right panel 106 and the posterior panel 102. In alternative embodiments where the right panel 106 is directly coupled to the posterior panel 102, the panels may be integral with one another.

The garment 100 may define an adjustable circumferential fit around the patient’s torso under the patient’s arms. The adjustable circumferential fit may be adjustable using the fastening system as discussed further herein. The adjustable circumferential fit may be greater than or equal to 10.0 inches, greater than or equal to 15.0 inches, greater than or equal to 20.0 inches, greater than or equal to 25.0 inches, etc., and/or less than or equal to 100.0 inches, less than or equal to 90.0 inches, less than or equal to 80.0 inches, less than or equal to 70.0 inches, etc. In at least one embodiment, the circumferential fit is greater than or equal to 16.0 inches and less than or equal to 75.0 inches.

The adjustable circumferential fit may fit human patients ranging from infants (e.g., two months old or older) to adults (e.g., 100 years old or younger) based on chest circumference measurements. The adjustable circumferential fit may fit human patients ranging from infants to adults by allowing the oscillating motors to rest upon the chest and/or torso of the patient, such that the oscillating motors target one or more of the five anatomical lung lobes of the patient. The five lung lobes include: the right upper lobe of the right lung, the right middle lobe of the right lung, the right lower lobe of the right lung, the left upper lobe of the left lung, and the left lower lobe of the left lung.

In one or more embodiments, the oscillating motors target one or more of the five lung lobes of the patient on one or both of the front and the back of the patient’s chest/torso. For example, in embodiments where only the back of the patient’s chest/torso are targeted, the patient may lay down on their back, and their weight may assist in providing stronger therapy against their back. Further, for example, in embodiments where only the front of the patient’s chest/torso is targeted, the patient may lay down on their front, and their weight may assist in providing stronger therapy against their front. Further, for example, in embodiments where both of the front and the back of the patient’s chest/torso is targeted, the patient may lay down on either their front or their back, and their weight may assist in providing stronger therapy against their front or their back, respectively.

In one or more embodiments, the oscillating motors target all five anatomical lung lobes of the patient. In one or more embodiments, the oscillating motors target all five anatomical lung lobes of the patient on one or both the front and the back of the patient’s chest/torso. The adjustable circumferential fit may be adjusted to target one or more of the five anatomical lung lobes of patients ranging from infants to adults. The adjustable circumferential fit may further allow the garment 100 to fit a variety of patients of different sizes and provide therapy to clear the patient’s airways of secretions.

Since patients of various sizes (e.g., from infants to adults) can use the garment, there may be more than one garment size to accommodate such different sizes and/or anatomies. Further, production of various sizes of the garment may allow each garment size to be designed for a better fit for patients using that garment size. The garment 100 may come in various distinct sizes. For example, the garment 100 may be produced in one or more of an “extra small,” a “small,” a “medium,” a “large,” and an “extra large” size. The “extra small” may have a circumferential fit of about 16.0 inches to about 23.0 inches. The “small” may have a circumferential fit of about 24.0 inches to about 35.0 inches. The “medium” may have a circumferential fit of about 36.0 inches to about 46.0 inches. The “large” may have a circumferential fit of about 47.0 inches to about 60.0 inches. The “extra large” may have a circumferential fit of about 61.0 inches to about 75.0 inches.

The garment 100 may define an adjustable torso surface fit between a surface of the patient’s torso and the garment 100. The adjustable torso surface fit may be adjustable using the fastening system 110 as described further herein. When the garment 100 is flush with the surface of the patient’s torso, the garment 100 may provide a stronger therapeutic effect than when the garment 100 is not flush with the surface of the patient’s torso. Thus, depending on patient therapy need and patient comfort, the adjustable torso surface fit may be adjusted.

The adjustable torso surface fit may further be adjusted to target one or more of the five anatomical lung lobes of patients ranging from infants to adults. The adjustable torso surface fit may further be adjusted to target the lobe(s) from the front and/or back of the patient. The adjustable torso surface fit, alone or coupled with the adjustable circumferential fit, may further allow a garment 100 to fit a variety of patients of different sizes and provide therapy to clear the patient’s airways of secretions.

The garment 100 may define a height, H (FIGS. 6 and 10). The height, H, may be measured along a vertical line bisecting the posterior panel 102, as illustrated in FIG. 6. The height, H, may range from, for example, 9.0 inches to 15.0 inches, 8.0 inches to 16.0 inches, 5.0 inches to 20.0 inches, etc. The height, H, may be standardized for the overall garment sizes (e.g., an “extra small” may have a height of about 9.5 inches, a “small” may have a height of about 12.5 inches, a “medium” may have a height of about 13.5 inches, a “large” may have a height of about 14.0 inches, and an “extra large” may have a height of about 14.5 inches). The height coupled with one or both of the adjustable circumferential fit and the adjustable torso surface fit, may further allow a garment 100 to comfortably fit a variety of patients of different sizes. The height coupled with one or both of the adjustable circumferential fit and the adjustable torso surface fit may further allow a garment 100 to fit a variety of patients of different sizes and provide therapy to clear the patient’s airways of secretions.

### The Fastening System

As illustrated in FIGS. 1-8, 10-13, 18, and 19, the garment 100 may include a fastening system 110 configured to couple the garment 100 to the patient. The fastening system 110 may be further configured to adjust a fit of the garment 100 to the patient. For example, the adjustable circumferential fit of the garment 100 around the patient’s torso may be adjustable using the fastening system 110. Further, for example, the adjustable torso surface fit of the garment 100 to the patient’s torso may be adjustable using the fastening system 110. Further, for example, the height of the garment 100 relative to the patient’s torso may be adjustable using the fastening system 110, as the garment 100 may be compressed or stretched to affect garment height relative to the patient’s torso.

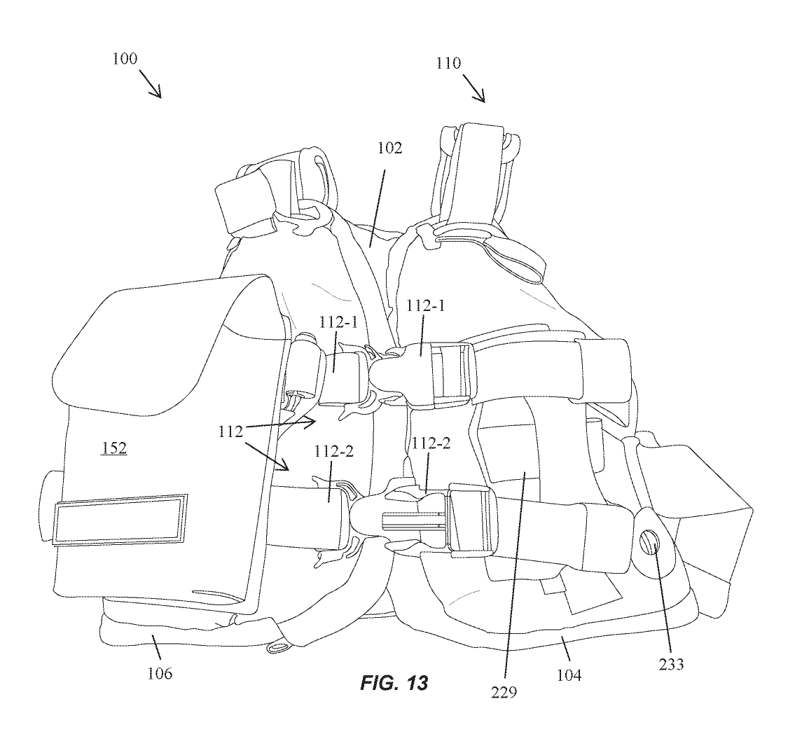

As illustrated in FIGS. 1, 4, 8, 11, and 13, the fastening system 110 may include one or more front straps 112 (e.g., 112-1, 112-2, FIGS. 1 and 13). The one or more front straps 112 may be configured to selectively couple the left panel 104 to the right panel 106. The one or more front straps 112 may be configured to modify the fit of the garment 100 to the patient. The one or more front straps 112 may each be adjustable using a cinch strap 113 (e.g., 113-1, 113-2) to adjust the fit of the garment 100 to the patient. Each of the one or more front straps 112 may define a strap width between 0.5 inches and 3.0 inches. In one or more embodiments (e.g., for garments sized “extra small”), each of the one or more front straps 112 defines a strap width of about 1.0 inches. In one or more embodiments (e.g., for garments sized “small,” “medium,” “large,” and/or “extra large”), each of the one or more front straps 112 defines a strap width of about 1.5 inches. The width of the one or more front straps may be comfortable for a user (e.g., the patient or a medical care provider) to grasp and operate.

The one or more front straps 112 may further include a buckle attachment 111 (e.g., 111-1, 111-2). As illustrated in FIGS. 1, 4, 8, 11, and 13, a male buckle attachment may be on the patient’s left side, and a female buckle attachment may be on the patient’s right side. In alternative embodiments not shown, the male and female buckle attachments may be switched between left and right sides. In alternative embodiments not shown, each of the one or more front straps 112 may be tied to close the garment 100 (instead of via the buckle attachments 111), or may be snapped, hook-and-loop attached, or otherwise attached to close the garment 100. In such alternative embodiments, each of the one or more front straps 112 may include left and right portions (as shown in the buckle embodiments shown) that are tied/snapped/hook-and-loop attached/etc. together to close the garment 100, or may include a single strap that is tied/snapped/hook-and-loop attached/etc. to a panel of the garment 100 to close the garment 100.

Additionally, and as illustrated in FIGS. 1-5 and 10, the fastening system 110 may further include a left shoulder strap 114a configured to selectively couple the left panel 104 and the posterior panel 102 over a left shoulder of the patient. The left shoulder strap 114a may be configured to modify the fit of the garment 100 to the patient. The left shoulder strap 114a may be adjustable using a cinch strap 115a to adjust the fit of the garment 100 to the patient. The left shoulder strap 114a may define a strap width between about 0.5 inches and about 3.0 inches. In one or more embodiments (e.g., for garments sized “extra small”), the left shoulder strap 114a defines a strap width of about 1.0 inches. In one or more embodiments (e.g., for garments sized “small,” “medium,” “large,” and/or “extra large”), the left shoulder strap 114a defines a strap width of about 1.5 inches. The width of the left shoulder strap 114a may be comfortable for a user to grasp and operate. Further, the width of the left shoulder strap 114a may comfortably distribute the weight of the garment 100 on the patient’s left shoulder.

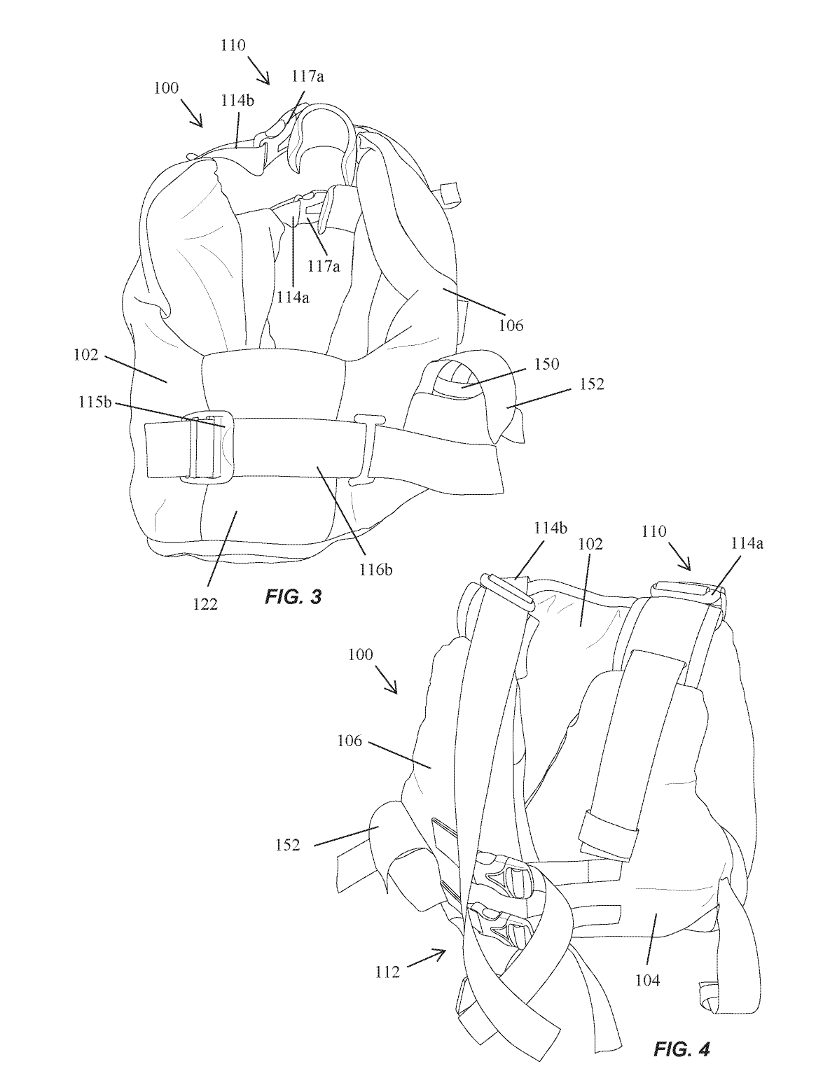

As illustrated in FIGS. 3 and 10, the left shoulder strap 114a may further include a buckle attachment 117a. As illustrated in FIGS. 1-8 and 10-12, a male buckle attachment may be on the patient’s front side, and a female buckle attachment may be on the patient’s rear side. In alternative embodiments not shown, the male and female buckle attachments may be switched between front and rear sides. In alternative embodiments not shown, the left shoulder strap 114a may be tied to close the garment 100 (instead of via the buckle attachment 117a), or may be hook-and-loop attached to close the garment 100. In such alternative embodiments, the left shoulder strap 114a may include front and back portions (as shown in the buckle embodiments shown) that are tied/hook-and-loop attached together to close the garment 100, or may include a single strap that is tied/hook-and-loop attached to a panel of the garment 100 to close the garment 100.

Additionally, as illustrated in FIGS. 1-5 and 10, the fastening system 110 may further include a right shoulder strap 114b configured to selectively couple the right panel 106 and the posterior panel 102 over a right shoulder of the patient. The right shoulder strap 114b may be configured to modify the fit of the garment 100 to the patient. The right shoulder strap 114b may be adjustable using a cinch strap 115b to adjust the fit of the garment 100 to the patient. The right shoulder strap 114b may define a strap width between 0.5 inches and 3.0 inches. In one or more embodiments (e.g., for garments sized “extra small”), the right shoulder strap 114b defines a strap width of about 1.0 inches. In one or more embodiments (e.g., for garments sized “small,” “medium,” “large,” and/or “extra large”), the right shoulder strap 114b defines a strap width of about 1.5 inches. The width of the right shoulder strap 114b may be comfortable for a user to grasp and operate. Further, the width of the right shoulder strap 114b may comfortably distribute the weight of the garment 100 on the patient’s right shoulder.

As illustrated in FIGS. 3 and 10, the right shoulder strap 114b may further include a buckle attachment 117b. As illustrated in FIGS. 1-8 and 10-12, a male buckle attachment may be on the patient’s front side, and a female buckle attachment may be on the patient’s rear side. In alternative embodiments not shown, the male and female buckle attachments may be switched between front and rear sides. In alternative embodiments not shown, the right shoulder strap 114b may be tied to close the garment 100 (instead of via the buckle attachment 117b), or may be hook-and-loop attached to close the garment 100. In such alternative embodiments, the right shoulder strap 114b may include front and back portions (as shown in the buckle embodiments shown) that are tied/hook-and-loop attached together to close the garment 100, or may include a single strap that is tied/hook-and-loop attached to a panel of the garment 100 to close the garment 100.

Additionally, and as illustrated in FIGS. 2, 6, 8, and 11, the fastening system 110 may further include an adjustable left side strap 116a. The adjustable left side strap 116a may be coupled to the left side panel 104 and the posterior panel 102. The adjustable left side strap 116a may be configured to adjust the fit of the garment 100 to the patient. For example, and as shown in FIGS. 2, 6, 8, and 11, the adjustable left side strap 116a may be adjustable using a cinch strap 115a to adjust the fit of the garment 100 to the patient. The adjustable left side strap 116a and/or the cinch strap 115a may define a strap width between 0.5 inches and 3.0 inches. In one or more embodiments, the adjustable left side strap 116a and/or the cinch strap 115a defines a strap width of 1.5 inches. The strap width of the adjustable left side strap 116a and/or the cinch strap 115a may be comfortable for a user to grasp and operate. In alternative embodiments not shown, the adjustable left side strap 116a may include multiple portions that are buckled, tied, snapped, hook-and-loop attached, or otherwise attached to adjust the fit of the garment 100.

Additionally, and as illustrated in FIGS. 3, 6, 8, and 11, the fastening system 110 may further include an adjustable right side strap 116b. The adjustable right side strap 116b may be coupled to the right side panel 106 and the posterior panel 102. The adjustable right side strap 116b may be configured to adjust the fit of the garment 100 to the patient. The adjustable right side strap 116b may be adjustable using a cinch strap 115b to adjust the fit of the garment 100 to the patient. The adjustable right side strap 116b and/or the cinch strap 115b may define a strap width between 0.5 inches and 3.0 inches. In one or more embodiments, the adjustable right side strap 116b and/or the cinch strap 115b defines a strap width of 1.5 inches. The strap width of the adjustable right side strap 116b and/or the cinch strap 115b may be comfortable for a user to grasp and operate. In alternative embodiments not shown, the adjustable right side strap 116b may include multiple portions that are buckled, tied, snapped, hook-and-loop attached, or otherwise attached to adjust the fit of the garment 100.

### The One or More Motors

The garment 100 may include one or more oscillation motors (e.g., one or more motors 200, FIGS. 12 and 21). Each motor 200 may be, for example, a brushed direct current (“DC”) motor, a brushless DC motor, etc. Each motor 200 may be configured to apply an oscillation force to at least one treatment area of the patient to mobilize secretions in an airway within the patient. The at least one treatment area may define one or more lung lobes of the patient. Further, secretions may be mobilized in an airway at least proximate to the treatment area. Still further, secretions may be mobilized in an airway at least proximate to the treatment area and mobilized away from the respiratory tract of the patient to clear the patient’s respiratory tract.

As illustrated in FIG. 12, the one or more motors 200 may include, for example, two motors 200 positioned within the right panel 106, four motors positioned in the posterior panel 102, and two motors positioned within the left panel 104. Such positions may provide direct dynamic oscillation of the patient’s left and right lungs, and may further target one or more of the five lung lobes. In one or more embodiments, all five lung lobes are targeted to clear the patient’s respiratory tract. In alternative embodiments, more or less motors may be positioned within each panel, respectively. For example, each panel may individually include between zero and twenty motors 200. The garment 100 includes at least one motor 200 in at least one of the plurality of panels 102, 104, 106.

Each of the one or more motors 200 may be electrically powered via, for example, an alternating current (“AC”) or DC power supply, such as, for example, one or more batteries, as discussed further herein. Each of the one or more motors 200 may be controlled by a printed circuit board, or “PCB” (e.g., PCB 300, FIG. 22). The PCB 300 may be powered by the same AC or DC power supply as the motors 200 and/or by a different power supply than the motors 200.

Each of the one or more motors 200 may produce a mechanical motion in response to the electrical input. For example, each of the one or more motors 200 may produce an oscillation motion (i.e., a percussive force applied to the patient in a perpendicular or generally perpendicular motion to the patient). Thus, each of the one or more motors 200 may include a percussion head that moves towards the patient and away from the motor, and vice versa. Each percussion head may be, for example, an offset circular counterweight. The motors 200 may induce a percussive force greater than or equal to about 1g (the force, in Newtons, per unit mass, in kilograms, due to gravity at the Earth’s surface) and less than or equal to 10g (the force per unit mass due to ten times the gravity at the Earth’s surface). In one or more embodiments, each of the motors 200 induces a percussive force ranging between and including about 2g and about 6g.

Each of the motors 200 may oscillate at a frequency greater than or equal to about 2 Hertz (“Hz”) and less than or equal to about 40 Hz. In one or more embodiments, the motors 200 oscillate at a frequency ranging between and including 5 Hz and 20 Hz.

The motors 200 may be controllable, as discussed further herein, to induce specific percussive forces, treatment protocols, patterns onto the patient’s torso/chest, and/or areas of treatment (e.g., one or more lung lobes) to mobilize secretions and clear the patient’s respiratory tract.

### The Control Unit and the Control Unit Pocket

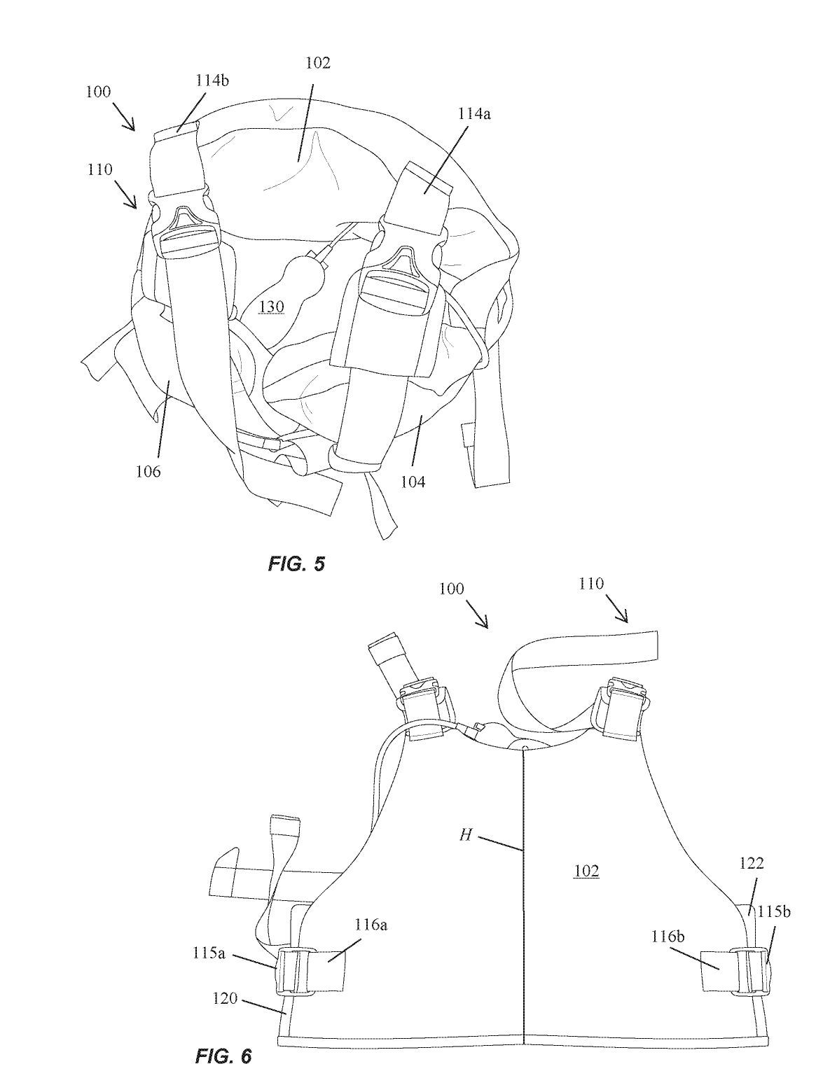

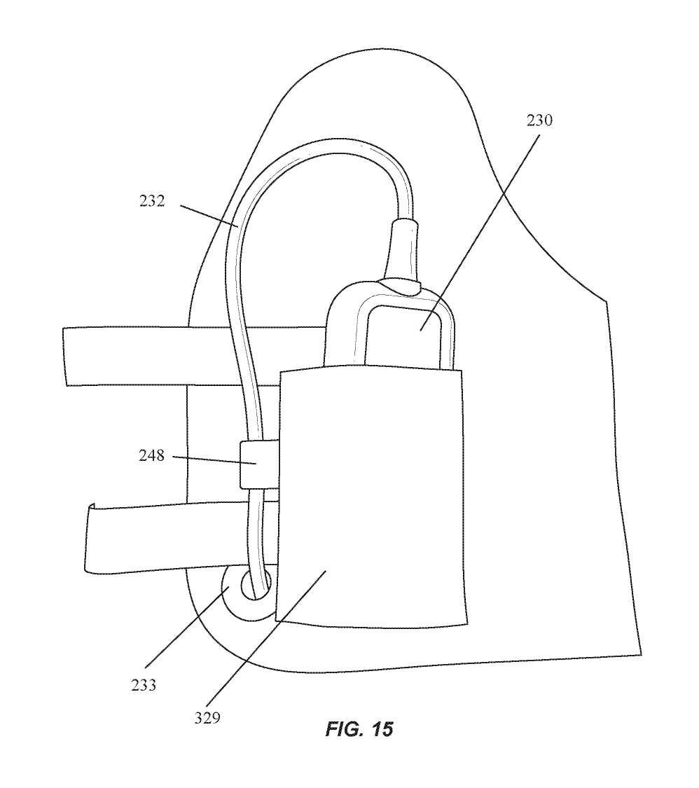

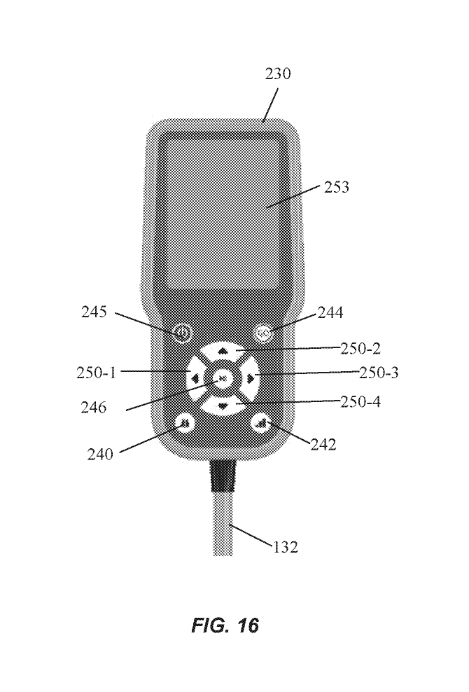

As illustrated in FIGS. 1 and 5, the garment 100 may further include a control unit 130. As illustrated in FIGS. 15 and 16, the garment 100 may further include a control unit 230. Elements described with respect to the control unit 130 may also be applicable to the same element described with respect to the control unit 230, unless otherwise noted.

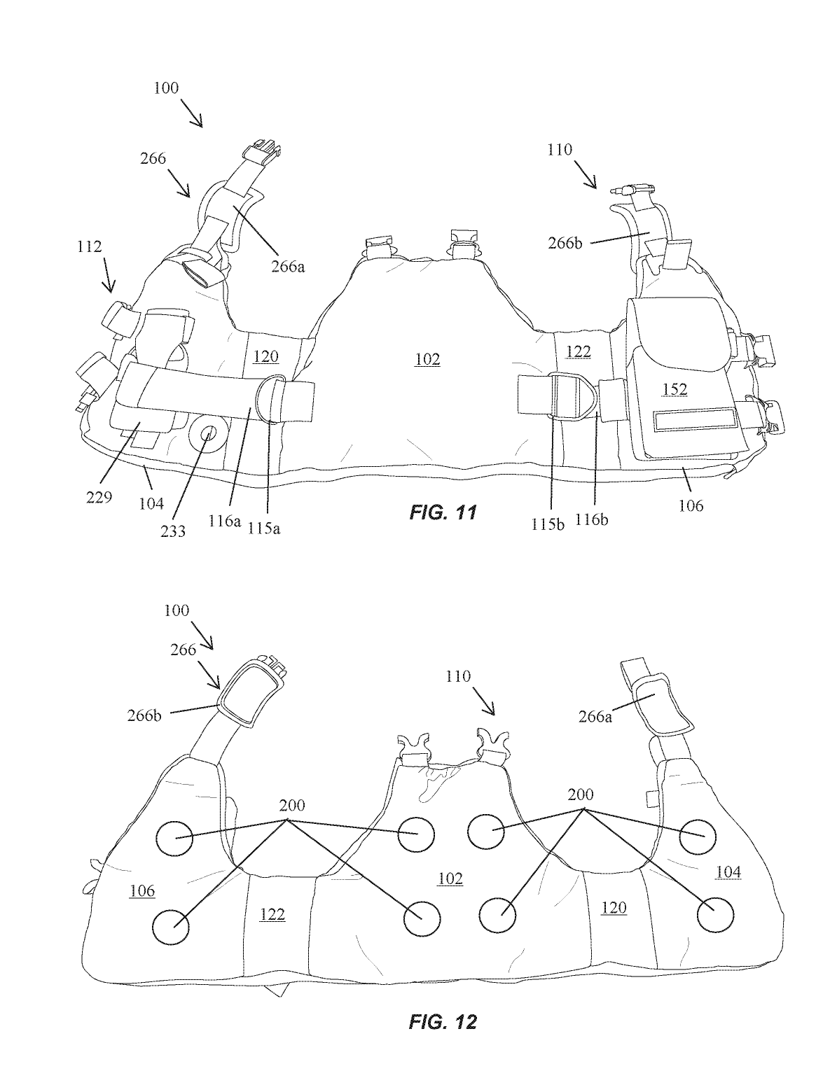

As illustrated in FIGS. 11, 13, 17, and 20, in one or more embodiments, the garment 100 further includes a control unit pocket 229 coupled to the left side panel 104. As illustrated in FIG. 15, in one or more embodiments, the garment 100 further includes a control unit pocket 329 coupled to the left side panel. In alternative embodiments, the control unit pocket 229, 329 may be coupled to another panel of the plurality of panels, or may be housed inside the accessible inner compartment. The control unit pocket 229, 329 may be configured to retain the control unit 130, 230 and may store the control unit 130, 230 when the garment 100 is in use and/or when the garment 100 is not in use. The control unit pocket 329 may include full front, side, and bottom panels (see FIG. 15), or may include partial front, side, and bottom panels (see control unit pocket 229 illustrated in FIGS. 11, 13, 17, and 20). More material may be more secure, and conversely, less material may be lighter and may further allow a user to view the control unit 130, 230 through the openings between the partial panels. In one or more embodiments, the control unit pocket 229, 329 may be configured to allow the user to press buttons on the control unit 130, 230 when the control unit 130, 230 is within the control unit pocket 229, 329, reducing the need to remove the control unit 130, 230 from the control unit pocket 229, 329 to use the control unit 130, 230.

The control unit pocket 229, 329 may be constructed out of durable material, such as, for example, nylon or another synthetic thermoplastic polymer, elastic, or any combination thereof. The control unit pocket 229, 329 may protect the control unit 130, 230 from the ambient environment and help prevent damage to the control unit 130, 230. In alternative embodiments, the control unit 130, 230 may be coupled to the left side panel 104 using a snap-in or clip-in mount attached to the left side panel 104.

The control unit 130, 230 may be coupled to each of the one or more motors 200 (FIGS. 12 and 20). The control unit 130, 230 may be coupled to each of the one or more motors 200 via electrical wiring 134 (FIGS. 18-20 and 22). The electrical wiring 134 may electrically couple each of the one or more motors 200 to the control unit 130, 230. The electrical wiring 134 may electrically couple each of the one or more motors 200 to a power source (e.g., battery 150, as described further herein). As illustrated in FIGS. 1, 16, and 19, the control unit 130, 230 may be coupled to the garment 100 via a control unit wire harness 132, 232. The control unit wire harness 132, 232 may house a portion of the electrical wiring 134.

The control unit wire harness 132, 232 may be between about 1.0 inch and about 40.0 inches, between about 2.0 inches and about 24.0 inches, between about 1.0 inch and about 10.0 inches, etc. In one or more embodiments, the control unit wire harness 132, 232 is less than or equal to about 40.0 inches long, less than or equal to about 35.0 inches long, less than or equal to about 30.0 inches long, less than or equal to about 20.0 inches long, etc., and/or greater than or equal to about 5.0 inches long, greater than or equal to about 10.0 inches long, greater than or equal to about 15.0 inches long, greater than or equal to about 25.0 inches long, greater than or equal to about 32.0 inches long, greater than or equal to about 36.0 inches long, etc.

In one or more embodiments, the control unit wire harness 132, 232, as measured between the control unit 130, 230 and the exterior surface of the garment 100, is less than or equal to about 12.0 inches long, less than or equal to about 10.0 inches long, less than or equal to about 5.0 inches long, etc., and/or greater than or equal to about 1.0 inch long, greater than or equal to about 7.0 inches long, greater than or equal to about 11.0 inches long, greater than or equal to about 12.5 inches long, etc.

The length of the control unit wire harness 132, 232, and/or the length of the control unit wire harness between the control unit 130, 230 and the exterior surface of the garment 100, may allow a user to hold the control unit 130, 230 in their hand or place the control unit 130, 230 in their lap or on a surface near them. A user may therefore comfortably and conveniently hold or place the control unit 130, 230 where they desire, and the control unit 130, 230 may remain within reaching distance for easy control of the garment 100.

In alternative embodiments (not shown), the control unit 130, 230 may be coupled to each of the one or more motors 200, the power source(s), and/or the PCB 300 without electrical wiring. In such alternative embodiments, there may not be a control unit wire harness 132, 232. In such alternative embodiments, the control unit 130, 230 may be coupled to each of the one or more motors 200, the power source(s), and/or the PCB 300 via Bluetooth and/or Wi-Fi. In such alternative embodiments, the control unit 130, 230 may allow a user to hold the control unit 130, 230 in their hand or place the control unit 130, 230 in their lap or on a surface near them without pulling on or disrupting the garment 100. A user may therefore comfortably and conveniently hold or place the control unit 130, 230 where they desire.

As illustrated in FIGS. 11, 13, 15, 17, and 20, the garment 100 may further define a garment aperture 233 through a front surface of the left panel 104 to an interior of the left panel 104. The garment aperture 233 may be located to avoid stress and/or strain on the control unit wire harness 232. The garment aperture 233 may be located such that the control unit wire harness 232 may be inobtrusive to the patient. For example, the garment aperture 233 may be located to the patient’s left of the control unit pocket (FIGS. 11, 13, 17, and 20), or may be located to the patient’s right of the control unit pocket (FIG. 15). The garment aperture 233 may be configured to allow the control unit wire harness 132, 232 and corresponding electrical wiring 134 to extend between the control unit 130, 230 and the one or more motors 200. The garment aperture 233 may be constructed of a durable material to avoid damage to the garment 100. In alternative embodiments (not shown), the control unit pocket 229 may define a pocket aperture configured to allow the control unit wire harness 132, 232 therethrough. Such alternative embodiments may avoid stress and/or strain on the control unit wire harness 232.

As illustrated in FIG. 15, the garment 100 may further include a harness guiding strap 248. The harness guiding strap 248 may guide the control unit wire harness 232 towards the garment aperture 233. The harness guiding strap 248 may avoid or reduce stress and/or strain on the control unit wire harness 232. The harness guiding strap 248 may include a first end and a second end. The first and second ends may each be coupled to the control unit pocket 229 and create a loop. In alternative embodiments, the first end may be coupled to the control unit pocket 229 and the second end may be coupled to the left side panel, or vice versa.

As illustrated in FIG. 1, the garment 100 may further include a clip 133 to restrain the control unit wire harness 132 against a portion of the garment 100. Restraining the control unit wire harness 132 against a portion of the garment 100 may avoid catching the control unit wire harness 132 on external objects and pulling the control unit 130 away from the garment 100, or pulling the garment 100 away from the patient wearing it.

In one or more embodiments, and as illustrated in FIG. 20, the clip 133 (shown schematically using a rectangle) may be located inside the accessible inner compartment (the accessible inner compartment 136 as described further herein). In such embodiment(s), the clip 133 may secure the control unit wire harness 132 to an internal component of the garment 100 (e.g., guiding strap 138 as discussed further herein). In such embodiment(s), the user may not be able to dislodge the clip 133 without first accessing the accessible inner compartment 136, resulting in a more secure clip 133. In alternative embodiments, and as illustrated in FIGS. 1 and 2, the clip 133 may be located outside the accessible inner compartment 136. In such alternative embodiments, the user may place the clip 133 against any external component of the garment 100 as desired, resulting in a more personalized clip placement.

The control unit 130, 230 may be configured to control each of the motors 200 to affect treatment of the patient. In one or more embodiments, the control unit 130, 230 may be configured to monitor data including at least one of: start time, end time, total elapsed time of an oscillation therapy delivered to the patient, and garment error codes for specific malfunctions (e.g., low battery, connectivity issues, etc.). In one or more embodiments, the control unit 130, 230 may be configured to store the monitored data in a memory. A user (e.g., the patient or a medical professional) may access the data in the memory from the control unit 130, 230. Such direct access to the data may allow the user to monitor the patient’s usage of the garment 100. The user may ensure the patient has complied with any prescribed treatment by analyzing the patient’s usage of the garment 100.

In one or more embodiments, the control unit 130, 230 may be configured to wirelessly connect to a user interface device (not shown, but including, for example, a cell phone, a smart watch, a computer, a tablet, a data server, a medical clinic, etc.). The control unit 130, 230 may include Bluetooth and/or Wi-Fi capabilities. The control unit 130, 230 may be configured to transmit the monitored data to the user interface device. Such transmittal of the data may allow the patient to monitor their own usage of the garment 100 on their personal devices. Such transmittal may further allow a medical professional to monitor the patient’s usage of the garment 100 at a medical clinic. The medical professional may ensure that the patient has complied with any prescribed treatment by analyzing the patient’s usage of the garment 100. In one or more embodiments, a medical professional may be able to control the garment 100 while the patient is wearing the garment 100 by controlling the control unit 130, 230 via Bluetooth and/or Wi-Fi capabilities.

As illustrated in FIG. 1, the control unit 130 may further include one or more of: a mode button 140 (e.g., 140-1, 140-2, 140-3), an intensity button 142 (e.g., 142-1, 142-2, 142-3), a preset oscillation therapy button 144, a power button 145, a start/stop button 146, and arrow buttons similar to those described with respect to FIG. 16. The description of the arrow buttons of FIG. 16 applies to the arrow buttons of FIG. 1 unless otherwise noted. As illustrated in FIG. 16, the control unit 230 may further include one or more of: a mode button 240, an intensity button 242, a preset oscillation therapy button 244, a power button 245, a start/stop button 246, and arrow button(s) 250 (e.g., 250-1, 250-2, 250-3, 250-4). The control unit 130, 230 may be configured to, for example, turn the garment 100 on and off, to start, pause, and stop the one or more motors 200, and to adjust one or more of: the intensity of the one or more motors, the oscillation therapy mode being delivered to the patient, the time of the oscillation therapy being delivered to the patient, etc.

The mode button 140, 240 may be configured to be actuatable by a user to select one of at least two oscillation therapies. In one or more embodiments, and as shown in FIG. 1, each oscillation therapy mode may have its own button (e.g., 140-1 may correspond to a first oscillation therapy mode, 140-2 may correspond to a second oscillation therapy mode, and 140-3 may correspond to a third oscillation therapy mode). In one or more alternative embodiments, and as shown in FIG. 16, the mode button 240 may be a singular button. The mode button 240 may be actuated (e.g., pressed) to change the desired oscillation therapy mode, and a variety of oscillation therapy modes may be cycled through using the mode button 240 until the desired oscillation therapy mode is selected. The currently selected oscillation therapy mode may be visible on a screen 153 (FIG. 1), 253 (FIG. 16). In one or more embodiments, the arrow button(s) may be used to scroll through a variety of oscillation therapy modes visible on the screen.

Various oscillation therapies/oscillation therapy modes may include, for example, targeted therapy to a specific treatment area, a pattern of targeted therapy across a treatment area or multiple treatment areas, etc. Such patterns of targeted therapy across a treatment area(s) may include beginning towards the bottom of the garment 100 and moving sequentially upwards towards the top of the garment 100, mobilizing lung secretions towards the patient’s trachea and mouth to be expelled. The one or more modes may control the one or more motors to create individual pressure waves that target one or more of the lobes of the lungs to mobilize secretions (e.g., by mimicking manual chest physical therapy (CPT)). There may be one or more of various unique modes such as, for example, “Percussion” (e.g., when a user presses button 140-1 or button 240), “Vibration” (e.g., when a user presses button 140-2 or button 240), and “Drainage” (e.g., when a user presses button 140-3 or button 240). In “Percussion” mode, all motors may operate in a pulsed fashion using a regular rhythm. In “Vibration” mode, all motors may be continuously on, providing deep oscillation of the thoracic cavity. In “Drainage” mode, individual zones of the patient’s chest and lungs may be activated in succession as therapy progresses up and down to mobilize secretions upward.

The intensity button 142, 242 may be configured to be actuatable by a user to select one of at least two intensities of the oscillation motors (e.g., motors 200, FIGS. 12 and 21). In one or more embodiments, and as shown in FIG. 1, each intensity may have its own button (e.g., 142-1 may correspond to a first motor intensity, 142-2 may correspond to a second motor intensity, and 142-3 may correspond to a third motor intensity). In one or more alternative embodiments, and as shown in FIG. 16, the intensity button 242 may be a singular button. The intensity button 242 may be actuated (e.g., pressed) to change the intensity, and a variety of intensities (e.g., low, medium, and high) may be cycled through using the intensity button 242 until the desired intensity is selected. The currently selected intensity may be visible on the screen 153, 253. In one or more embodiments, the arrow button(s) may be used to scroll through a variety of intensities visible on the screen.

Each of the at least two intensities may define an oscillation frequency of each of the one or more motors. In one or more embodiments, the at least two intensities define a first intensity with an oscillation frequency of about 5 Hertz (Hz). In one or more embodiments, the at least two intensities define a second intensity with an oscillation frequency of about 13 Hertz (Hz). In one or more embodiments, the at least two intensities define a third intensity with an oscillation frequency of about 20 Hertz (Hz). In one or more embodiments, additional intensities may be included. A higher intensity may provide a relatively stronger therapeutic effect. A lower intensity may provide a relatively weaker therapeutic effect (e.g., for patients that do not require a stronger therapeutic effect or are susceptible to discomfort, a lower intensity may be effective and/or comfortable). A lower intensity may require less energy from the power source (e.g., battery 150). Each oscillation therapy (e.g., preset therapy sessions, pattern of therapy, therapy modes, etc.) may have a set intensity based on the patient’s needs.

The preset oscillation therapy button 144 (FIG. 1), 244 (FIG. 16) may be configured to start a preset, or prescribed, oscillation therapy. For example, the preset oscillation therapy may include a preset mode, a preset intensity, and/or preset time. Each of the preset mode, intensity, and/or time may either remain constant throughout the preset oscillation therapy, or may change during the preset oscillation therapy. The preset oscillation therapy button 144, 244 may reduce the number of buttons required to start a therapy. Reducing the number of buttons required to start a therapy may be especially beneficial for patients suffering from lack of, or reduced, finger dexterity. Reducing the number of buttons required to start a therapy may also be simple for a user to use, where the user might not want to memorize multiple steps of new technology, or who might not want to spend time toggling to other modes and intensities using the arrow button(s) as described further herein.

The start/stop button 146 (FIG. 1), 246 (FIG. 16) may be configured to alternatively start the garment 100 into being in use or stop the garment 100 from being in use. The start/stop button 146, 246 may be used to quickly start and/or stop the garment 100 into/from being in use.

In one or more embodiments, the control unit 130, 230 includes one or more arrow button(s) 250. The arrow button(s) 250 may be used for user interface navigation through menu screens. Additionally, the arrow button(s) 250 may also be used to set the desired treatment mode, intensity, and/or time for the standalone therapy and/or the preset treatment. Still further, the arrow button(s) 250 can also be used to scroll through the mode, intensity, treatment time, etc., instead of pressing the specific mode and intensity buttons.

In one or more embodiments, the screen 153, 253 may be a touch screen and allow for selection of mode, intensity, preset oscillation therapy, power, start/stop, arrows, and/or time using the screen 153, 253. In such touch screen embodiments, there may be less or no physical buttons. In one or more embodiments, the screen 153, 253 may not be a touch screen. Some users may prefer a touch screen, while others may not.

### The Accessible Inner Compartment

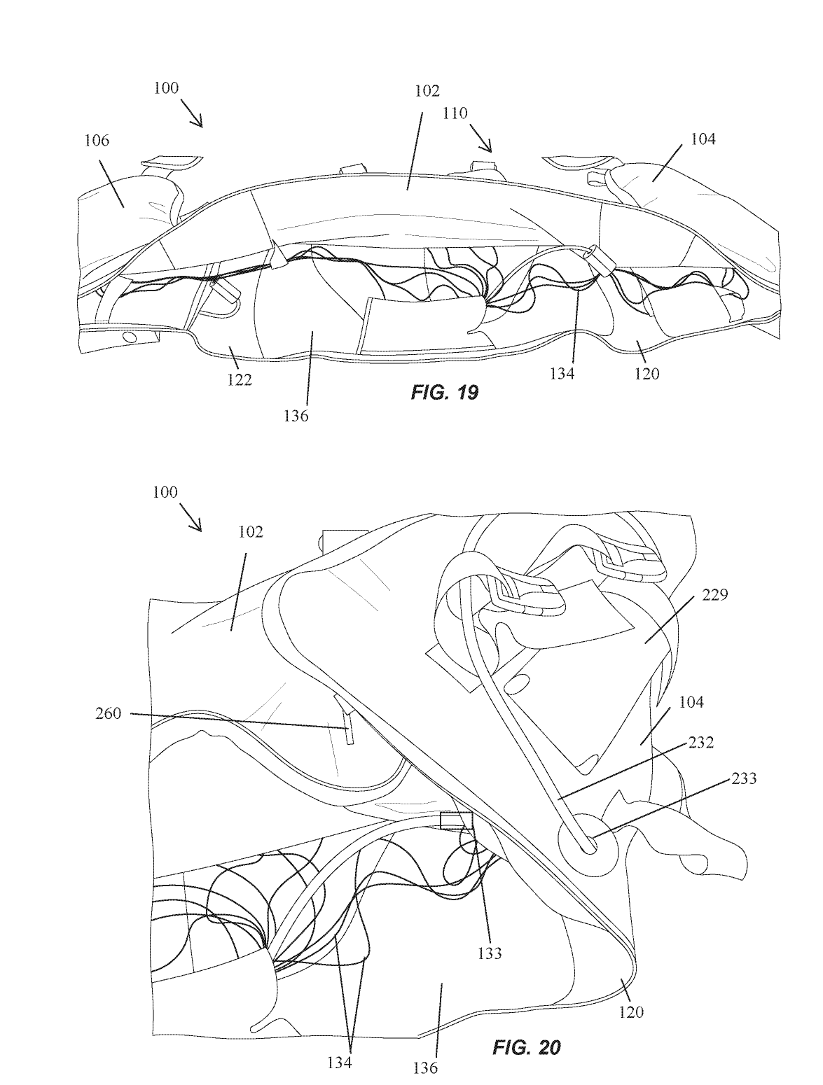

As illustrated in FIGS. 17-22, the garment 100 may further include an accessible inner compartment 136. The accessible inner compartment 136 may be defined by at least one of the plurality of panels (102, 104, 106). As illustrated in FIGS. 18 and 19, in at least one embodiment, the accessible inner compartment 136 may be defined by each and every panel of the plurality of panels (102, 104, 106). An accessible inner compartment 136 that extends farther along the garment 100 may allow a user to more easily access the inner compartment (e.g., for maintenance and repair). Conversely, an accessible inner compartment 136 that does not extend as far along the garment 100 may further protect the inner compartment from external elements and damage.

The accessible inner compartment 136 may be configured to retain at least a portion of the electrical wiring 134. The accessible inner compartment 136 may include one or more guiding straps 138 (e.g., 138-1, 138-2, 138-3) positioned within the accessible inner compartment 136. The one or more guiding straps 138 may be configured to guide the electrical wiring 134 throughout the accessible inner compartment 136.

In one or more embodiments, the one or more guiding straps 138 include a first guiding strap 138-1. The first guiding strap 138-1 may be positioned within the accessible inner compartment 136 of the posterior panel 102. The first guiding strap 138-1 may be configured to hold a printed circuit assembly (e.g., PCB 300, FIG. 22). In one or more embodiments, the first guiding strap 138-1 may include multiple portions with hook-and-loop fasteners to close the first guiding strap 138-1. In one or more embodiments, the first guiding strap 138-1 may include only one portion of an elastic material that stretches to allow the printed circuit assembly to be installed within the first guiding strap 138-1.

In one or more embodiments, the one or more guiding straps 138 include a second guiding strap 138-2. The second guiding strap 138-2 may be positioned within the accessible inner compartment 136 of the left panel 104. The second guiding strap 138-2 may be configured to hold, or guide, a portion of the electrical wiring 134. The second guiding strap 138-2 may keep the electrical wiring 134 in its initial position within the accessible inner compartment 136 regardless of movement (e.g., twisting, dropping, etc.) of the garment 100. Thus, each of the motors 200 may remain properly electrically coupled to the control unit 130, and the electrical wiring 134 does not pinch or break.

In one or more embodiments, the one or more guiding straps 138 include a third guiding strap 138-3. The third guiding strap 138-3 may be positioned within the accessible inner compartment 136 of the right panel 106. The third guiding strap 138-3 may be configured to hold, or guide, a portion of the electrical wiring 134. The third guiding strap 138-3 may keep the electrical wiring 134 in its initial position within the accessible inner compartment 136 regardless of movement (e.g., twisting, dropping, etc.) of the garment 100. Thus, each of the motors 200 may remain properly electrically coupled to the control unit 130, and the electrical wiring 134 does not pinch or break.

### The Battery and the Battery Pocket

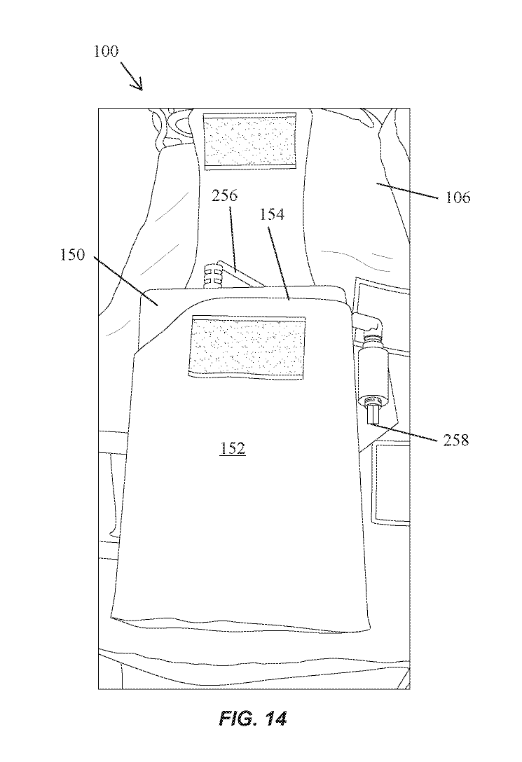

As illustrated in FIGS. 3 and 14, the garment 100 may further include a power source, such as a battery 150. The battery 150 may be coupled to each of the one or more motors 200 (FIGS. 12 and 21) via the electrical wiring 134 to provide power to the one or more motors 200. The battery 150 may be coupled to the control unit 130 via the electrical wiring 134 to provide power to the control unit 130. In one or more embodiments, the battery 150 may be coupled to each of the one or more motors 200 via the control unit 130. For example, the battery 150 may provide power to the control unit 130, and the control unit 130 acts as a motor controller to pulse width modulate battery power to each of the one or more motors 200. In alternative embodiments, the battery 150 may be coupled to each of the one or more motors 200 via electromagnetic induction.

As illustrated in FIGS. 1, 4, 8, 11, 13, and 14, the garment 100 may further include a battery pocket 152. The battery pocket 152 may be coupled to the right panel 106. In alternative embodiments, the battery pocket 152 may be coupled to another panel of the plurality of panels, or may be housed inside the accessible inner compartment. The battery pocket 152 may be configured to retain the battery 150. The battery pocket 152 may be fluid-impervious, which may protect the battery 150 from moisture and extend the life of the battery 150. The battery pocket 152 may be shaped and sized to retain the battery 150 in a snug fit.

The battery pocket 152 may define a pocket aperture 154. As illustrated in FIG. 14, the pocket aperture 154 may be configured to allow a charging cable 256 therethrough. The charging cable 256 may house a portion of the electrical wiring 134. The garment 100 may further define a garment aperture 258 (FIG. 14) through a front surface of the right panel 106 to an interior of the right panel 106. The garment aperture 258 may be configured to allow the charging cable 256 and corresponding electrical wiring 134 between the battery 150 and the one or more motors 200.

The garment aperture 258 may be located to avoid stress and/or strain on the charging cable 256. The garment aperture 258 may be configured to allow the charging cable 256 and corresponding electrical wiring to extend between the battery 150 and the PCB 300, the control unit 130, 230, and/or the one or more motors 200. The garment aperture 258 may be constructed of a durable material to avoid damage to the garment 100.

The garment 100 may further include a charging cable guiding strap (not shown). The charging cable guiding strap may guide the charging cable 256 towards the garment aperture 258. The charging cable guiding strap may avoid or reduce stress and/or strain on the charging cable 256. The charging cable guiding strap may include a first end and a second end. The first and second ends may each be coupled to the battery pocket 152 and create a loop. In alternative embodiments, the first end may be coupled to the battery pocket 152 and the second end may be coupled to the right side panel, or vice versa.

### Additional Elements – the Zipper and the Shoulder Pads

As illustrated in FIGS. 17 and 20, the garment 100 may include a zipper 260. The zipper 260 may be configured to open or close the accessible inner compartment 136. The garment 100 may further include a zipper pocket 262 (FIG. 17). The zipper pocket 262 may be configured to retain the zipper 260 such that the zipper 260 does not hang off of the garment 100. The zipper pocket 262 may keep the accessible inner compartment 136 closed and protect the internal components of the garment 100.

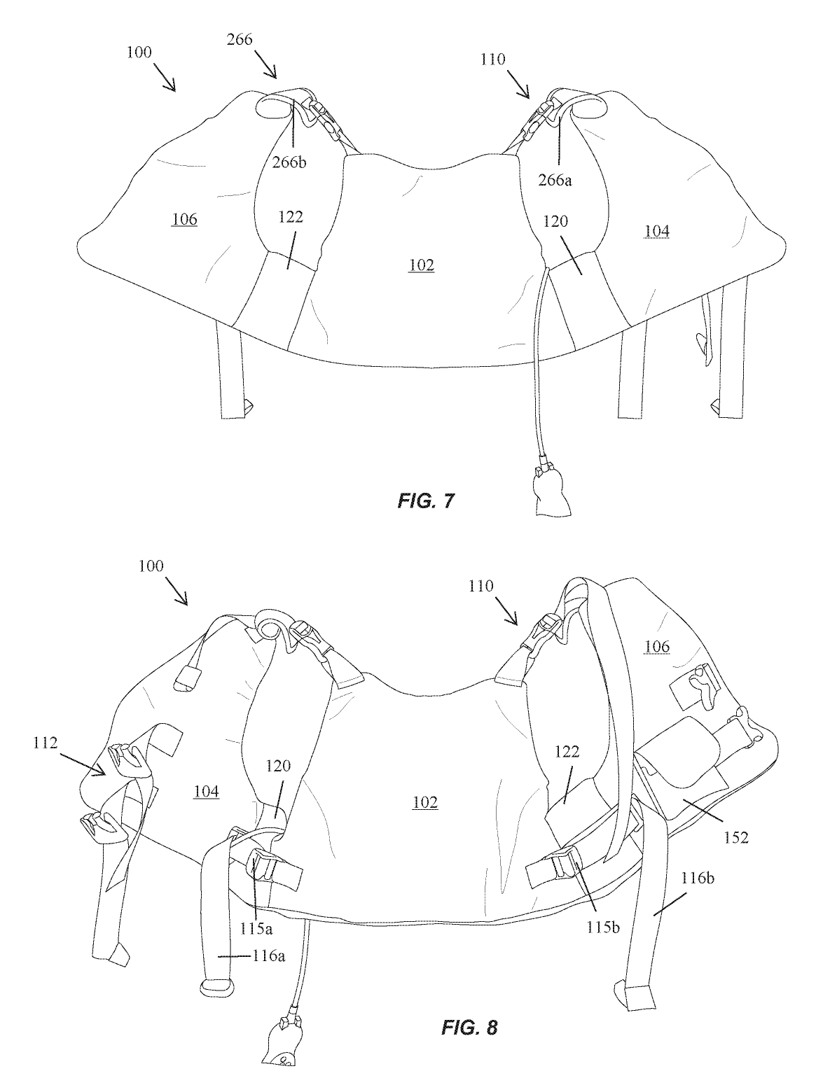

As illustrated in FIGS. 7 and 10-12, the garment 100 may further include shoulder pads 266 (e.g., 266a, 266b). The shoulder pads 266a, 266b may be positioned between each of the left and right shoulder straps 114a, 114b and the left and right shoulders of the patient, respectively, when the garment 100 is worn. The shoulder pads 266 may provide comfort to the patient when the garment 100 is worn.

### Methods

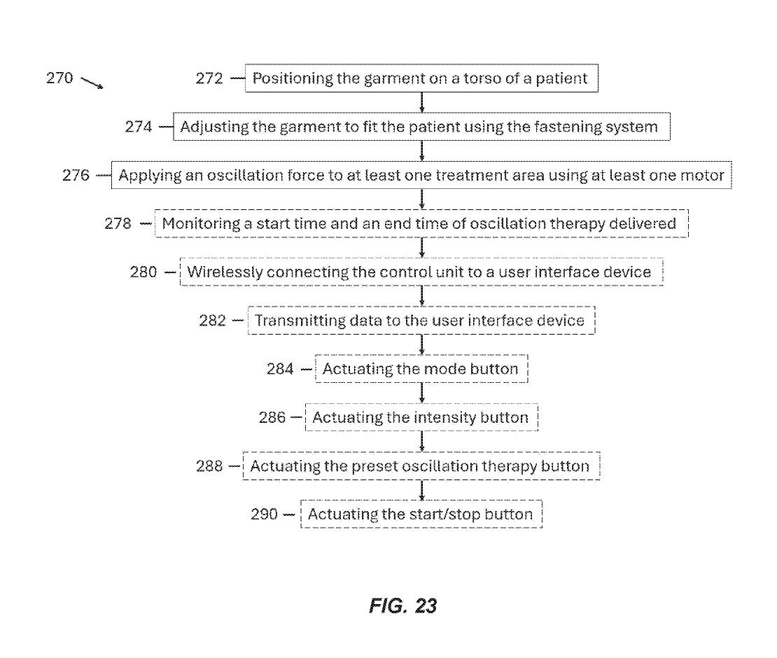

As illustrated in FIG. 23, a method 270 of clearing a biological airway (e.g., the patient’s respiratory tract) using the garment 100 as described herein may include positioning the garment 100 on a torso of a patient (indicated as 272 in FIG. 23). The method 270 may further include adjusting the garment 100 to fit the patient using the fastening system 110 (indicated as 274 in FIG. 23). Adjusting the garment to fit the patient may include adjusting one or more of: adjusting the adjustable circumferential fit, adjusting the adjustable torso surface fit, adjusting the height relative to the patient’s torso, etc.

The method 270 may further include applying an oscillation force to at least one treatment area using at least one of the one or more motors 200 such that at least some secretions in an airway within the patient substantially adjacent the at least one treatment area are mobilized (indicated as 276 in FIG. 23). Applying an oscillation force to at least one treatment area may include applying an oscillation force to one or more lung lobes as discussed herein.

Positioning the garment 100 on the torso of the patient (indicated as 272 in FIG. 23) may further optionally include selectively coupling the left panel 104 to the right panel 106 using the at least one front strap 112. Further, for example, positioning the garment 100 on the torso of the patient (indicated as 272 in FIG. 23) may optionally include selectively coupling the left panel 104 and the posterior panel 102 over a left shoulder of the patient using the left shoulder strap 114a. Further, for example, positioning the garment 100 on the torso of the patient (indicated as 272 in FIG. 23) may optionally include selectively coupling the right panel 106 and the posterior panel 102 over a right shoulder of the patient using the right shoulder strap 114b.

Adjusting the garment to fit the patient using the fastening system (indicated as 274 in FIG. 23) may optionally include adjusting the at least one front strap 112 to modify the circumferential fit. Further, for example, adjusting the garment to fit the patient using the fastening system (indicated as 274 in FIG. 23) may further include adjusting the adjustable left side strap 116a to modify the circumferential fit and/or the torso surface fit. Further, for example, adjusting the garment to fit the patient using the fastening system (indicated as 274 in FIG. 23) may further include adjusting the adjustable right side strap 116b to modify the circumferential fit and/or the torso surface fit. Further, for example, adjusting the garment to fit the patient using the fastening system (indicated as 274 in FIG. 23) may further include adjusting the left shoulder strap 114a to modify the circumferential fit and/or the torso surface fit. Further, for example, adjusting the garment to fit the patient using the fastening system (indicated as 274 in FIG. 23) may further include adjusting the right shoulder strap 114b to modify the circumferential fit and/or the torso surface fit.

Applying an oscillation force to at least one treatment area using at least one of the one or more motors (indicated as 276 in FIG. 23) may further include turning the garment 100 on and off, starting, pausing, and stopping the one or more motors 200, and/or adjusting one or more of: the intensity of the one or more motors, the oscillation therapy mode being delivered to the patient, the time of the oscillation therapy being delivered to the patient, the oscillation therapy being delivered to the patient, etc.

Optional steps of the method 270 are illustrated in FIG. 23 using dashed line boxes. The method 270 may further optionally include monitoring a start time and an end time of oscillation therapy delivered to the patient using the control unit 130 (indicated as 278 using optional dashed lines in FIG. 23). Data including the start and end time may be stored and reviewed by the user, and may further be used to ensure compliance with a therapy protocol or prescription.

The method 270 may further optionally include wirelessly connecting the control unit 130 to a user interface device (indicated as 280 using optional dashed lines in FIG. 23). The method 270 may further optionally include transmitting data to the user interface device, the data comprising a start time and an end time of oscillation therapy delivered to the patient (indicated as 282 using optional dashed lines in FIG. 23).

The method 270 may further optionally include one or more of: actuating the mode button to select one of at least two oscillation therapy modes or oscillation therapies (indicated as 284 using optional dashed lines in FIG. 23), actuating the intensity button to select one of at least two intensities of the oscillation motors (indicated as 286 using optional dashed lines in FIG. 23), actuating the preset oscillation therapy button (indicated as 288 using optional dashed lines in FIG. 23), and actuating the start/stop button (indicated as 290 using optional dashed lines in FIG. 23). The buttons are described in more detail herein above.

### Illustrative Embodiments

Example Ex1. A garment to provide therapy to a patient comprising:
a plurality of panels comprising:
   a posterior panel configured to be positioned adjacent the patient’s back;
   a left panel coupled to the posterior panel and configured to be positioned adjacent the patient’s left front torso; and
   a right panel coupled to the posterior panel and configured to be positioned adjacent the patient’s right front torso,
   a fastening system configured to couple the garment to the patient and to adjust a fit of the garment to the patient and comprising:
      one or more front straps configured to selectively couple the left panel to the right panel, and further configured to modify the fit of the garment to the patient;
      a left shoulder strap configured to selectively couple the left panel and the posterior panel over a left shoulder of the patient, and further configured to modify the fit of the garment to the patient;
      a right shoulder strap configured to selectively couple the right panel and the posterior panel over a right shoulder of the patient, and further configured to modify the fit of the garment to the patient;
      an adjustable left side strap coupled to the left panel and the posterior panel and configured to adjust the fit of the garment to the patient; and
      an adjustable right side strap coupled to the right panel and the posterior panel, the adjustable right side strap configured to adjust the fit of the garment to the patient;
      one or more motors configured to apply an oscillation force to at least one treatment area of the patient to mobilize secretions in an airway within the patient at least proximate the at least one treatment area; and
      a control unit coupled to the one or more motors and the garment and configured to control the one or more motors to affect treatment of the patient.

Example Ex2. The garment of any one of Examples Ex1 and Ex3-Ex20, wherein the garment defines an adjustable circumferential fit around the patient’s torso under the patient’s arms that is adjustable using the fastening system, and wherein the adjustable circumferential fit is greater than or equal to 16 inches and equal to or less than 75 inches.

Example Ex3. The garment of any one of Examples Ex1-Ex2 and Ex4-Ex20, wherein the garment defines a height measured along a vertical line bisecting the posterior panel, and the height ranges from 9 inches to 15 inches.

Example Ex4. The garment of any one of Examples Ex1-Ex3 and Ex5-Ex20, further comprising:
a left flexible element coupled to and extending between the left panel and the posterior panel; and
a right flexible element coupled to and extending between the right panel and the posterior panel.

Example Ex5. The garment of any one of Examples Ex1-Ex4 and Ex6-Ex20, further comprising:
electrical wiring electrically coupling each of the one or more motors to a power source and operably coupling each of the one or more motors to the control unit; and
an accessible inner compartment defined by at least one of the plurality of panels and configured to retain at least a portion of the electrical wiring.

Example Ex6. The garment of any one of Examples Ex1-Ex5 and Ex7-Ex20, further comprising one or more guiding straps positioned within the accessible inner compartment and configured to guide the electrical wiring throughout the accessible inner compartment.

Example Ex7. The garment of any one of Examples Ex1-Ex6 and Ex8-Ex20, wherein the one or more guiding straps comprise a first guiding strap positioned within the accessible inner compartment of the posterior panel, the first guiding strap further configured to hold a printed circuit assembly.

Example Ex8. The garment of any one of Examples Ex1-Ex7 and Ex9-Ex20, wherein the one or more guiding straps comprise:
a second guiding strap positioned within the accessible inner compartment of the left panel; and
a third guiding strap positioned within the accessible inner compartment of the right panel.

Example Ex9. The garment of any one of Examples Ex1-Ex8 and Ex10-Ex20, further comprising:
a zipper configured to open or close the accessible inner compartment; and
a zipper pocket configured to retain the zipper.

Example Ex10. The garment of any one of Examples Ex1-Ex9 and Ex11-Ex20, wherein the control unit is configured to adjust one or more of:
an intensity of the one or more motors, wherein the intensity defines an oscillation frequency of the one or more motors; and
an oscillation therapy being delivered to the patient.

Example Ex11. The garment of any one of Examples Ex1-Ex10 and Ex12-Ex20, further comprising a battery coupled to the one or more motors and the control unit to provide power to the one or more motors and the control unit.

Example Ex12. The garment of any one of Examples Ex1-Ex11 and Ex13-Ex20, wherein the garment further comprises shoulder pads positioned between each of the left and right shoulder straps and the left and right shoulders of the patient, respectively, when the garment is worn.

Example Ex13. The garment of any one of Examples Ex1-Ex12 and Ex14-Ex20, wherein each of the one or more front straps, left and right shoulder straps, and left and right adjustable side straps are adjustable using a cinch strap to adjust the fit of the garment to the patient.

Example Ex14. The garment of any one of Examples Ex1-Ex13 and Ex15-Ex20, wherein each of the plurality of panels comprises:
a first outer layer distal to the patient;
a first inner layer between the first outer layer and each of the one or more motors;
a second inner layer laterally surrounding each of the one or more motors;
a third inner layer between each of the one or more motors and the patient; and
a second outer layer between the third inner layer and the patient, the second outer layer proximal to the patient.

Example Ex15. The garment of any one of Examples Ex1-Ex14 and Ex16-Ex20, further comprising a battery pocket coupled to the right panel and configured to retain the battery.

Example Ex16. The garment of any one of Examples Ex1-Ex15 and Ex17-Ex20, further comprising a control unit pocket coupled to the left panel and configured to retain the control unit.

Example Ex17. The garment of any one of Examples Ex1-Ex16 and Ex18-Ex20, wherein the control unit is configured to monitor time of oscillation therapy delivered to the patient.

Example Ex18. The garment of any one of Examples Ex1-Ex17 and Ex19-Ex20, wherein the control unit is configured to wirelessly connect to a user interface device and transmit data to the user interface device, the data comprising a time of oscillation therapy start delivered to the patient and a time of oscillation therapy end.

Example Ex19. The garment of any one of Examples Ex1-Ex18 and Ex20, wherein the control unit comprises:
a mode button configured to be actuatable by a user to select one of at least two oscillation therapies;
an intensity button configured to be actuatable by the user to select one of at least two intensities of the one or more motors, each of the at least two intensities defining an oscillation frequency of the one or more motors;
a preset oscillation therapy button; and
a start/stop button.

Example Ex20. The garment of any one of Examples Ex1-Ex19, wherein the one or more motors comprises:
two motors positioned within the right panel;
four motors positioned within the posterior panel; and
two motors positioned within the left panel.

Example Ex21. A garment to provide therapy to a patient comprising:
a plurality of panels comprising:
   a posterior panel configured to be positioned adjacent the patient’s back;
   a left panel coupled to the posterior panel and configured to be positioned adjacent the patient’s left front torso; and
   a right panel coupled to the posterior panel and configured to be positioned adjacent the patient’s right front torso,
   a fastening system configured to couple the garment to the patient and to adjust a fit of the garment to the patient;
   one or more motors configured to apply an oscillation force to at least one treatment area of the patient to mobilize secretions in an airway within the patient at least proximate the at least one treatment area;
   electrical wiring electrically coupling each of the one or more motors to a power source;
   an accessible inner compartment defined by at least one of the plurality of panels and configured to retain at least a portion of the electrical wiring; and
   one or more guiding straps positioned within the accessible inner compartment and configured to guide the electrical wiring throughout the accessible inner compartment.

Example Ex22. The garment of any one of Examples Ex21 and Ex23-Ex40, wherein the fastening system comprises:
one or more front straps configured to selectively couple the left panel to the right panel, and further configured to modify the fit of the garment to the patient;
a left shoulder strap configured to selectively couple the left panel and the posterior panel over a left shoulder of the patient, and further configured to modify the fit of the garment to the patient;
a right shoulder strap configured to selectively couple the right panel and the posterior panel over a right shoulder of the patient, and further configured to modify the fit of the garment to the patient;
an adjustable left side strap coupled to the left panel and the posterior panel and configured to adjust the fit of the garment to the patient; and
an adjustable right-side strap coupled to the right panel and the posterior panel and configured to adjust the fit of the garment to the patient.

Example Ex23. The garment of any one of Examples Ex21-Ex22 and Ex24-Ex40, further comprising a control unit coupled to the one or more motors and the garment and configured to control the one or more motors to affect treatment of the patient.

Example Ex24. The garment of any one of Examples Ex21-Ex23 and Ex25-Ex40, wherein the garment defines an adjustable circumferential fit around the patient’s torso under the patient’s arms that is adjustable using the fastening system, and wherein the adjustable circumferential fit is greater than or equal to 16 inches and equal to or less than 75 inches.

Example Ex25. The garment of any one of Examples Ex21-Ex24 and Ex26-Ex40, wherein the garment defines a height measured along a vertical line bisecting the posterior panel, and the height ranges from 9 inches to 15 inches.

Example Ex26. The garment of any one of Examples Ex21-Ex25 and Ex27-Ex40, further comprising:
a left flexible element coupled to and extending between the left panel and the posterior panel; and
a right flexible element coupled to and extending between the right panel and the posterior panel.

Example Ex27. The garment of any one of Examples Ex21-Ex26 and Ex28-Ex40, wherein the one or more guiding straps comprise a first guiding strap positioned within the accessible inner compartment of the posterior panel, the first guiding strap further configured to hold a printed circuit assembly.

Example Ex28. The garment of any one of Examples Ex21-Ex27 and Ex29-Ex40, wherein the one or more guiding straps comprise:
a second guiding strap positioned within the accessible inner compartment of the left panel; and
a third guiding strap positioned within the accessible inner compartment of the right panel.

Example Ex29. The garment of any one of Examples Ex21-Ex28 and Ex30-Ex40, further comprising:
a zipper configured to open or close the accessible inner compartment; and
a zipper pocket configured to retain the zipper.

Example Ex30. The garment of any one of Examples Ex21-Ex29 and Ex31-Ex40, wherein the control unit is configured to adjust one or more of:
an intensity of the one or more motors, wherein the intensity defines an oscillation frequency of the one or more motors; and
an oscillation therapy being delivered to the patient.

Example Ex31. The garment of any one of Examples Ex21-Ex30 and Ex32-Ex40, further comprising a battery coupled to the one or more motors and the control unit to provide power to the one or more motors and the control unit.

Example Ex32. The garment of any one of Examples Ex21-Ex31 and Ex33-Ex40, wherein the garment further comprises shoulder pads positioned between each of the left and right shoulder straps and the left and right shoulders of the patient, respectively, when the garment is worn.

Example Ex33. The garment of any one of Examples Ex21-Ex32 and Ex34-Ex40, wherein each of the at least one front strap, left and right shoulder straps, and left and right side straps are adjustable using a cinch strap to adjust the fit of the garment to the patient.

Example Ex34. The garment of any one of Examples Ex21-Ex33 and Ex35-Ex40, wherein each of the plurality of panels comprises:
a first outer layer distal to the patient;
a first inner layer between the first outer layer and each of the one or more motors;
a second inner layer laterally surrounding each of the one or more motors;
a third inner layer between each of the one or more motors and the patient; and
a second outer layer between the third inner layer and the patient, the second outer layer proximal to the patient.

Example Ex35. The garment of any one of Examples Ex21-Ex34 and Ex36-Ex40, further comprising a battery pocket coupled to the right panel and configured to retain the battery.

Example Ex36. The garment of any one of Examples Ex21-Ex35 and Ex37-Ex40, further comprising a control unit pocket coupled to the left panel and configured to retain the control unit.

Example Ex37. The garment of any one of Examples Ex21-Ex36 and Ex38-Ex40, wherein the control unit is configured to monitor time of oscillation therapy delivered to the patient.

Example Ex38. The garment of any one of Examples Ex21-Ex37 and Ex39-Ex40, wherein the control unit is configured to wirelessly connect to a user interface device and transmit data to the user interface device, the data comprising a time of oscillation therapy delivered to the patient.

Example Ex39. The garment of any one of Examples Ex21-Ex38 and Ex40, wherein the control unit comprises:
a mode button configured to be actuatable by a user to select one of at least two oscillation therapies;
an intensity button configured to be actuatable by the user to select one of at least two intensities of the one or more motors, each of the at least two intensities defining an oscillation frequency of the one or more motors;
a preset oscillation therapy button; and
a start/stop button.

Example Ex40. The garment of any one of Examples Ex21-Ex39, wherein the one or more motors comprises:
two motors positioned within the right panel;
four motors positioned within the posterior panel; and
two motors positioned within the left panel.

Example Ex41. A method of clearing a biological airway, comprising:
positioning a garment on a torso of a patient, the garment comprising one or more motors and a fastening system, the fastening system comprising at least one front strap, a right shoulder strap, a left shoulder strap, a right side strap, and a left side strap;
adjusting the garment to fit the patient using the fastening system; and
applying an oscillation force to at least one treatment area using at least one of the one or more motors such that at least some secretions in an airway within the patient substantially adjacent the at least one treatment area are mobilized.

Example Ex42. The method of any one of Examples Ex41 and Ex43-Ex63, wherein the garment further comprises:
a plurality of panels comprising:
   a posterior panel configured to be positioned adjacent the patient’s back;
   a left panel coupled to the posterior panel and configured to be positioned adjacent the patient’s left front torso; and
   a right panel coupled to the posterior panel and configured to be positioned adjacent the patient’s right front torso.

Example Ex43. The method of any one of Examples Ex41-Ex42 and Ex44-Ex63, wherein positioning the garment on the torso of the patient comprises:
selectively coupling the left panel to the right panel using the at least one front strap;
selectively coupling the left panel and the posterior panel over a left shoulder of the patient using the left shoulder strap; and
selectively coupling the right panel and the posterior panel over a right shoulder of the patient using the right shoulder strap.

Example Ex44. The method of any one of Examples Ex41-Ex43 and Ex45-Ex63, wherein the garment defines an adjustable circumferential fit around the patient’s torso under the patient’s arms that is adjustable using the fastening system, and wherein adjusting the garment to fit the patient using the fastening system further comprises:
adjusting the at least one front strap to modify the adjustable circumferential fit;
adjusting the left side strap to modify the adjustable circumferential fit, the left side strap coupled to the left panel and the posterior panel; and
adjusting the right-side strap to modify the adjustable circumferential fit, the right-side strap coupled to the right panel and the posterior panel.

Example Ex45. The method of any one of Examples Ex41-Ex44 and Ex46-Ex63, wherein the adjustable circumferential fit is greater than or equal to 16 inches and equal to or less than 75 inches.

Example Ex46. The method of any one of Examples Ex41-Ex45 and Ex47-Ex63, wherein the garment defines an adjustable torso surface fit between a surface of the patient’s torso and the garment that is adjustable using the fastening system, and wherein adjusting the garment to fit the patient using the fastening system further comprises:
adjusting the left shoulder strap to modify the adjustable torso surface fit; and
adjusting the right shoulder strap to modify the adjustable torso surface fit.

Example Ex47. The method of any one of Examples Ex41-Ex46 and Ex48-Ex63, wherein each of one or more front straps, the left shoulder strap, and the right shoulder strap are adjustable using a cinch strap.

Example Ex48. The method of any one of Examples Ex41-Ex47 and Ex49-Ex63, wherein each of the left side strap and the right side strap are adjustable using a cinch strap.

Example Ex49. The method of any one of Examples Ex41-Ex48 and Ex50-Ex63, wherein the garment defines a height measured along a vertical line bisecting the posterior panel, and the height ranges from 9 inches to 15 inches.

Example Ex50. The method of any one of Examples Ex41-Ex49 and Ex51-Ex63, wherein the garment further comprises:
a left flexible element coupled to and extending between the left panel and the posterior panel; and
a right flexible element coupled to and extending between the right panel and the posterior panel.

Example Ex51. The method of any one of Examples Ex41-Ex50 and Ex52-Ex63, wherein the garment further comprises:
electrical wiring electrically coupling each of the one or more motors to a power source;
an accessible inner compartment defined by at least one of the plurality of panels and configured to retain at least a portion of the electrical wiring; and
one or more guiding straps positioned within the accessible inner compartment and configured to guide the electrical wiring throughout the accessible inner compartment.

Example Ex52. The method of any one of Examples Ex41-Ex51 and Ex53-Ex63, wherein the one or more guiding straps comprise:
a first guiding strap positioned within the accessible inner compartment of the posterior panel, the first guiding strap further configured to hold a printed circuit assembly;
a second guiding strap positioned within the accessible inner compartment of the left panel; and
a third guiding strap positioned within the accessible inner compartment of the right panel.

Example Ex53. The method of any one of Examples Ex41-Ex52 and Ex54-Ex63, wherein the garment further comprises:
a zipper configured to open or close the accessible inner compartment; and
a zipper pocket configured to retain the zipper.

Example Ex54. The method of any one of Examples Ex41-Ex53 and Ex55-Ex63, wherein applying an oscillation force to at least one treatment area using at least some of the one or more motors further comprises:
adjusting one or more of:
   an intensity of the one or more motors, wherein the intensity defines an oscillation frequency of the one or more motors; and
   an oscillation therapy being delivered to the patient.

Example Ex55. The method of any one of Examples Ex41-Ex54 and Ex56-Ex63, wherein the garment further comprises a battery coupled to the one or more motors to provide power to the one or more motors.

Example Ex56. The method of any one of Examples Ex41-Ex55 and Ex57-Ex63, wherein the garment further comprises shoulder pads positioned between each of the left and right shoulder straps and the left and right shoulders of the patient, respectively, when the garment is worn.

Example Ex57. The method of any one of Examples Ex41-Ex56 and Ex58-Ex63, wherein each of the plurality of panels comprises:
a first outer layer distal to the patient;
a first inner layer between the first outer layer and each of the one or more motors;
a second inner layer laterally surrounding each of the one or more motors;
a third inner layer between each of the one or more motors and the patient; and
a second outer layer between the third inner layer and the patient, the second outer layer proximate the patient.

Example Ex58. The method of any one of Examples Ex41-Ex57 and Ex59-Ex63, wherein the garment further comprises a battery pocket coupled to the right panel and configured to retain the battery.

Example Ex59. The method of any one of Examples Ex41-Ex58 and Ex60-Ex63, wherein the garment further comprises:
a control unit coupled to each of the one or more motors and the battery; and
a control unit pocket coupled to the left panel and configured to retain the control unit.

Example Ex60. The method of any one of Examples Ex41-Ex59 and Ex61-Ex63, further comprising monitoring a start time and an end time of oscillation therapy delivered to the patient using the control unit.

Example Ex61. The method of any one of Examples Ex41-Ex60 and Ex62-Ex63, further comprising:
wirelessly connecting the control unit to a user interface device; and
transmitting data to the user interface device, the data comprising a start time and an end time of oscillation therapy delivered to the patient.

Example Ex62. The method of any one of Examples Ex41-Ex61 and Ex63, further comprising one or more of:
actuating a mode button to select one of at least two oscillation therapies;
actuating an intensity button to select one of at least two intensities of the one or more motors, each of the at least two intensities defining an oscillation frequency of the one or more motors;
actuating a preset oscillation therapy button; and
actuating a start/stop button.

Example Ex63. The method of any one of Examples Ex41-Ex62, wherein the one or more motors comprises:
two motors positioned within the right panel;
four motors positioned within the posterior panel; and
two motors positioned within the left panel.

The complete disclosure of the patents, patent documents, and publications cited herein are incorporated by reference in their entirety as if each were individually incorporated. In the event that any inconsistency exists between the disclosure of the present application and the disclosure(s) of any document incorporated herein by reference, the disclosure of the present application shall govern.

Illustrative embodiments are described and reference has been made to possible variations of the same. These and other variations, combinations, and modifications will be apparent to those skilled in the art, and it should be understood that the claims are not limited to the illustrative embodiments set forth herein.

1. A garment to provide therapy to a patient comprising:
a plurality of panels comprising:
a posterior panel configured to be positioned adjacent the patient’s back;
a left panel coupled to the posterior panel and configured to be positioned adjacent the patient’s left front torso; and
a right panel coupled to the posterior panel and configured to be positioned adjacent the patient’s right front torso;
a fastening system configured to couple the garment to the patient and to adjust a fit of the garment to the patient and comprising:
one or more front straps configured to selectively couple the left panel to the right panel, and further configured to modify the fit of the garment to the patient;
a left shoulder strap configured to selectively couple the left panel and the posterior panel over a left shoulder of the patient, and further configured to modify the fit of the garment to the patient;
a right shoulder strap configured to selectively couple the right panel and the posterior panel over a right shoulder of the patient, and further configured to modify the fit of the garment to the patient;
an adjustable left side strap coupled to the left panel and the posterior panel and configured to adjust the fit of the garment to the patient; and
an adjustable right side strap coupled to the right panel and the posterior panel, the adjustable right side strap configured to adjust the fit of the garment to the patient;
one or more motors configured to apply an oscillation force to at least one treatment area of the patient to mobilize secretions in an airway within the patient at least proximate the at least one treatment area; and
a control unit coupled to the one or more motors and the garment and configured to control the one or more motors to affect treatment of the patient.

2. The garment of claim 1, wherein the garment defines an adjustable circumferential fit around the patient’s torso under the patient’s arms that is adjustable using the fastening system, and wherein the adjustable circumferential fit is greater than or equal to 16 inches and equal to or less than 75 inches.

3. The garment of claim 1, wherein the garment defines a height measured along a vertical line bisecting the posterior panel, and the height ranges from 9 inches to 15 inches.

4. The garment of claim 1, further comprising:
a left flexible element coupled to and extending between the left panel and the posterior panel; and
a right flexible element coupled to and extending between the right panel and the posterior panel.

5. The garment of claim 1, further comprising:
electrical wiring electrically coupling each of the one or more motors to a power source and operably coupling each of the one or more motors to the control unit; and
an accessible inner compartment defined by at least one of the plurality of panels and configured to retain at least a portion of the electrical wiring.

6. The garment of claim 5, further comprising one or more guiding straps positioned within the accessible inner compartment and configured to guide the electrical wiring throughout the accessible inner compartment.

7. The garment of claim 6, wherein the one or more guiding straps comprise a first guiding strap positioned within the accessible inner compartment of the posterior panel, the first guiding strap further configured to hold a printed circuit assembly.

8. The garment of claim 1, wherein the control unit is configured to adjust one or more of:
an intensity of the one or more motors, wherein the intensity defines an oscillation frequency of the one or more motors; and
an oscillation therapy being delivered to the patient.

9. The garment of claim 1, wherein each of the plurality of panels comprises:
a first outer layer distal to the patient;
a first inner layer between the first outer layer and each of the one or more motors;
a second inner layer laterally surrounding each of the one or more motors;
a third inner layer between each of the one or more motors and the patient; and
a second outer layer between the third inner layer and the patient, the second outer layer proximate the patient.

10. The garment of claim 1, further comprising:
a battery coupled to the one or more motors and the control unit to provide power to the one or more motors and the control unit; and
a battery pocket coupled to the right panel and configured to retain the battery.

11. The garment of claim 1, further comprising a control unit pocket coupled to the left panel and configured to retain the control unit.

12. The garment of claim 1, wherein the control unit is configured to monitor time of oscillation therapy delivered to the patient.

13. The garment of claim 1, wherein the control unit is configured to wirelessly connect to a user interface device and transmit data to the user interface device, the data comprising a time of oscillation therapy start delivered to the patient and a time of oscillation therapy end.

14. The garment of claim 1, wherein the control unit comprises:
a mode button configured to be actuatable by a user to select one of at least two oscillation therapies;
an intensity button configured to be actuatable by the user to select one of at least two intensities of the one or more motors, each of the at least two intensities defining an oscillation frequency of the one or more motors;
a preset oscillation therapy button; and
a start/stop button.

15. A garment to provide therapy to a patient comprising:
a plurality of panels comprising:
a posterior panel configured to be positioned adjacent the patient’s back;
a left panel coupled to the posterior panel and configured to be positioned adjacent the patient’s left front torso; and
a right panel coupled to the posterior panel and configured to be positioned adjacent the patient’s right front torso,
a fastening system configured to couple the garment to the patient and to adjust a fit of the garment to the patient;
one or more motors configured to apply an oscillation force to at least one treatment area of the patient to mobilize secretions in an airway within the patient at least proximate the at least one treatment area;
electrical wiring electrically coupling each of the one or more motors to a power source;
an accessible inner compartment defined by at least one of the plurality of panels and configured to retain at least a portion of the electrical wiring; and
one or more guiding straps positioned within the accessible inner compartment and configured to guide the electrical wiring throughout the accessible inner compartment.

16. The garment of claim 15, wherein the fastening system comprises:
one or more front straps configured to selectively couple the left panel to the right panel, and further configured to modify the fit of the garment to the patient;
a left shoulder strap configured to selectively couple the left panel and the posterior panel over a left shoulder of the patient, and further configured to modify the fit of the garment to the patient;
a right shoulder strap configured to selectively couple the right panel and the posterior panel over a right shoulder of the patient, and further configured to modify the fit of the garment to the patient;
an adjustable left side strap coupled to the left panel and the posterior panel and configured to adjust the fit of the garment to the patient; and
an adjustable right side strap coupled to the right panel and the posterior panel and configured to adjust the fit of the garment to the patient.

17. The garment of claim 15, further comprising a control unit coupled to the one or more motors and configured to control the one or more motors to affect treatment of the patient.

18. The garment of claim 15, wherein the garment defines an adjustable circumferential fit around the patient’s torso under the patient’s arms that is adjustable using the fastening system, and wherein the adjustable circumferential fit is greater than or equal to 16 inches and equal to or less than 75 inches.

19. The garment of claim 15, wherein the garment defines a height measured along a vertical line bisecting the posterior panel, and the height ranges from 9 inches to 15 inches.

20. The garment of claim 15, further comprising:
a left flexible element coupled to and extending between the left panel and the posterior panel; and
a right flexible element coupled to and extending between the right panel and the posterior panel.
